(19) United States
(12) Patent Application Publication
(10) Pub. No.: US 2026/0281185 A1
(43) Pub. Date: Sep. 17, 2026

(54) SYSTEM

(71) Applicant: SoftBank Group Corp., Tokyo (JP)

(72) Inventor: Takashi WAKAMATSU, Tokyo (JP)

(73) Assignee: SoftBank Group Corp., Tokyo (JP)

(21) Appl. No.: 19/550,301

(22) Filed: Feb. 26, 2026

Related U.S. Application Data
(60) Provisional application No. 63/769,936, filed on Mar. 11, 2025.

(51) Int. Cl. H04L 67/125; G06F 40/279; G06N 3/0475; H04W 4/029

(52) U.S. Cl. CPC H04L 67/125; G06N 3/0475; H04W 4/029; G06F 40/279

(57) ABSTRACT

There is provided a system comprising a processor, wherein the processor is configured to collect, in real time, position information of objects each provided with an RFID tag, store the collected position information and record past movement histories of the objects in a database, receive, as input, real-time data from the position information collection and past data from the database, and perform movement prediction for the objects by using a generative artificial intelligence module, and generate, based on the movement prediction by the generative artificial intelligence module, instructions indicating optimal timings for lending, borrowing, or transshipment of the objects.

### CROSS-REFERENCE TO RELATED APPLICATION

This application claims the benefit of U.S. Provisional Application No. 63/769,936, filed on Mar. 11, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional asset and logistics management systems that rely on RFID technology typically focus on simple identification and tracking of objects, without providing advanced prediction or proactive operational guidance. In such systems, position information of RFID-tagged objects is often collected intermittently, stored in fragmented or isolated databases, and used only for retrospective inquiries. As a result, operators are unable to accurately forecast future movements of objects, such as the next location, movement direction, or expected arrival time. This limitation makes it difficult to optimize timings for lending, borrowing, loading, unloading, or transshipment operations, and causes inefficiencies such as idle time, congestion at docks or workstations, delayed responses to demand fluctuations, and suboptimal utilization of human and physical resources. Furthermore, existing systems generally lack an integrated mechanism that combines real-time RFID-based location data, historical movement histories, and machine learning-based predictive analysis to automatically generate and distribute precise instructions to users or workers at the right time. Therefore, there is a need for a system that not only collects and stores RFID-based position information in real time, but also predicts future movements of objects and automatically issues operation instructions, thereby enabling more efficient logistics, inventory, and asset management.

### SUMMARY

In order to solve the above problem, according to one aspect of the present invention, there is provided a system comprising a processor, wherein the processor is configured to collect, in real time, position information of objects each provided with an RFID tag, to store the collected position information and record past movement histories of the objects in a database, to receive, as input, real-time data from position information collection and past data from the database, and to perform movement prediction for the objects by using a generative artificial intelligence module. The processor is further configured to generate, based on the movement prediction by the generative artificial intelligence module, instructions indicating optimal timings for lending, borrowing, or transshipment of the objects. The processor may be configured to detect, by using an RFID reader, information of RFID tags that are within a specific range, to transmit the detected information to the database via wireless communication, and to update, in real time, position information of each RFID tag in the database while accumulating past position information to record a movement history for each object. The processor may also be configured to analyze, by using a machine learning algorithm, real-time position information and past movement histories to predict a next movement direction and speed of each object, to send a notification to a next user in accordance with a predicted arrival time of the object at a specific place based on the movement prediction, and to send a notification to a worker at an optimal timing when transshipment of the object is required. By these means, the system integrates RFID-based real-time location tracking, historical data management, and generative AI-based prediction and instruction generation in a unified architecture, thereby enabling proactive and optimized control of lending, borrowing, loading, unloading, and transshipment operations.

The term “RFID tag” refers to a radio frequency identification device attached to or embedded in an object, which stores a unique identifier and optionally additional data, and which can be read wirelessly by an RFID reader without line-of-sight contact. The term “RFID reader” refers to a device configured to emit radio frequency signals, to wirelessly communicate with RFID tags within a readable range, and to obtain tag information such as unique identifiers and stored data.

The term “position information” refers to data that indicates a physical or logical location of an object at a given time, including, for example, coordinates, zone identifiers, shelf identifiers, dock identifiers, vehicle identifiers, or other location-related identifiers within a facility or transport network.

The term “movement history” refers to a chronological record of changes in the position information of an object, including for each record at least a location identifier and a timestamp, and optionally terminal identifiers or other metadata.

The term “database” refers to one or more data storage systems, which may be implemented using relational, non-relational, time-series, or other database technologies, and which are configured to store, update, and retrieve position information, movement histories, predictions, and instructions.

The term “real time” refers to processing or updating that occurs substantially without delay relative to the actual occurrence of an event, such that position information of an object is collected, transmitted, and stored within a time period short enough to be practically usable for immediate operational decisions.

The term “generative artificial intelligence module” refers to a software component that uses a generative model, such as a machine learning model or neural network, to produce prediction outputs or inferred information based on input data, including but not limited to predicting future movements, destinations, arrival times, or demand patterns for objects.

The term “machine learning algorithm” refers to a computational method or model that is trained using data to identify patterns and relationships, and that is configured to perform tasks such as classification, regression, sequence prediction, or time-series forecasting related to object movements and demand.

The term “movement prediction” refers to an estimated future state of an object's movement, including at least one of a predicted next location, a predicted movement direction, a predicted speed, or a predicted arrival time at a specific place, generated based on real-time data and past movement history.

The term “instruction” refers to data indicating an operation to be performed with respect to an object, including at least a description of the action, an associated object or item identifier, and an execution time or timing condition, and optionally one or more target users or devices to receive the instruction.

The term “instruction generation” refers to a process in which the system creates one or more instructions based on movement predictions, operational rules, and system state, including determination of content, timing, and recipients of the instructions.

The term “lending” refers to a temporary transfer of possession or use rights of an object from one user or entity to another, while ownership remains unchanged, including but not limited to rental, loan, or temporary allocation.

The term “borrowing” refers to the act of receiving temporary possession or use rights of an object from another user or entity under a lending arrangement, while the object remains owned by the lending party.

The term “transshipment” refers to the transfer of an object from one transport vehicle, container, storage location, or handling equipment to another, typically as part of a logistics, distribution, or inventory management process.

The term “user” refers to a human operator, worker, staff member, or other person who interacts with the system, receives instructions, or performs physical operations such as lending, borrowing, loading, unloading, or transshipment.

The term “terminal” refers to any device used by a user or installed on equipment or infrastructure, including handheld devices, vehicle-mounted terminals, fixed shelf terminals, or other computing devices, that are configured to read RFID tags, display instructions, or communicate with the system.

The term “processor” refers to one or more processing units, which may include CPUs, microcontrollers, DSPs, GPUs, or other computing hardware, configured to execute software instructions that implement the functions of collecting position information, managing the database, performing generative AI processing, and generating instructions as described in the claims.

The term “system” refers to the entirety of hardware and software components, including the processor, RFID readers, communication interfaces, databases, generative artificial intelligence module, and terminals, that collectively perform the functions of real-time tracking, prediction, and instruction generation as claimed.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

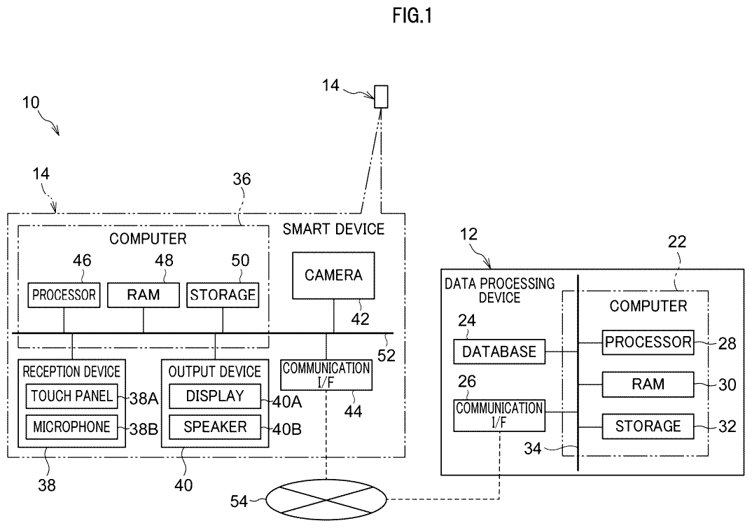

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

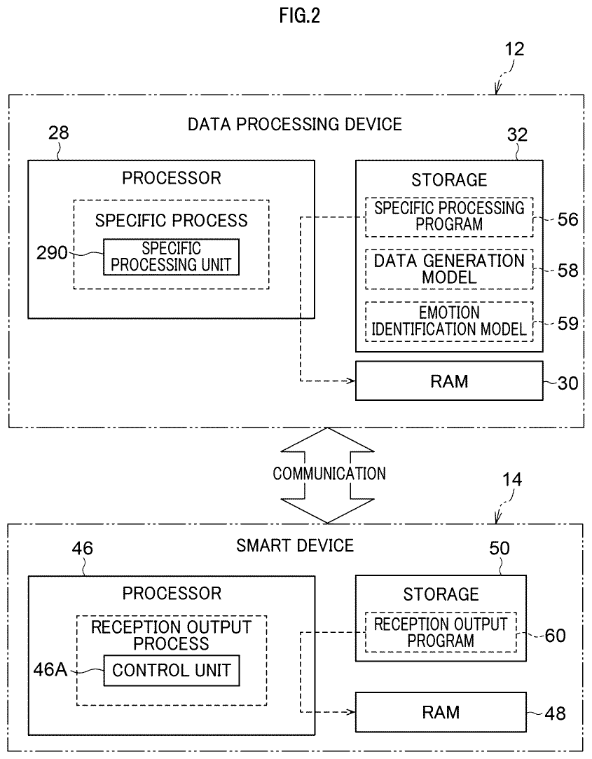

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented logistics and asset-management systems typically collect location data from identification tags and store such data in databases, but they rely on static rules or manually designed algorithms to generate operational plans. As a result, these systems often exhibit several technical limitations. First, the processing pipeline from data acquisition to instruction generation is fragmented: raw sensor data is stored at a low level of abstraction, and subsequent planning logic must repeatedly transform and filter the same data, causing redundant computations, increased memory traffic, and latency in producing actionable results. Second, when machine-learning components are used, they are usually implemented as fixed-purpose models with rigid interfaces, and they do not flexibly adapt their input representation or query form in response to changes in system performance, thereby limiting prediction accuracy and robustness under dynamic workloads. Furthermore, in many existing systems, the interaction with a machine-learning model is treated as a black-box call that consumes predefined numerical features. The system does not systematically construct or refine a textual or structured query optimized for the model, nor does it use downstream execution results as feedback to adjust how the query is generated. This leads to suboptimal utilization of computing resources: prediction requests may include irrelevant or poorly structured data, which increases processing time inside the model, reduces the quality of the generated predictions, and forces additional corrective logic in later stages. In addition, the linkage between predicted results and concrete task scheduling on terminals (including timing, ordering, and assignment of tasks to devices) is often handled by separate procedural code, which further increases complexity and can cause inconsistent state between stored histories, predicted values, and actual execution results.

From a computer-technology standpoint, there is a need for an improved architecture and processing method in which a processor orchestrates the entire loop of (i) acquisition and normalization of position information, (ii) generation of structured data and natural-language prompt sentences, (iii) invocation of a generative AI model, (iv) derivation and distribution of concrete task instructions, and (v) collection of execution feedback, in a way that is machine-adapted and self-refining. Specifically, there is a need for a system in which the processor not only calls a generative AI model but also programmatically constructs and adaptively updates prompt sentences based on measured prediction error and work efficiency, so that the internal data representation and query formulation are automatically optimized over time. Such a system can reduce computational overhead for downstream correction, improve the accuracy and timeliness of predictions, and provide more efficient end-to-end computer processing for logistics and inventory operations.

The specific processing by the specific processing unit 290 of the data processing device 12 in Example 1 is realized by the following means.

The present invention provides a server comprising a processor and a memory storing instructions which, when executed by the processor, cause the processor to acquire position information data of objects associated with identification information via an information reading device, normalize and store the position information data as current position information and movement history information in a storage subsystem, generate structured data representing selected history information based on predetermined extraction conditions, construct a prompt sentence in a natural language on the basis of the structured data and operation condition information, input the prompt sentence to a generative AI model to obtain prediction information relating to future destinations, movement times, or demand quantities, compute task instruction information including at least one of a start time, an execution order, and an assigned apparatus for operations, distribute the task instruction information to information terminals, and receive and store work result information from the information terminals as evaluation data, while adaptively updating at least one of a composition, a content, and included history information of the prompt sentence in accordance with prediction error derived from comparison between the prediction information and the work result information. This enables an integrated and computer-centric improvement in how location histories are transformed into optimized operational instructions, by allowing the server to automatically tune the interaction with the generative AI model and to refine the internal data processing pipeline based on measured system performance, thereby enhancing prediction accuracy, reducing computational redundancy, and improving the overall efficiency and responsiveness of logistics and inventory management operations.

The term “processor” refers to a hardware computation component, such as a central processing unit or a programmable logic device, that executes instructions to perform arithmetic, logic, control, and data-handling operations within the system.

The term “information processing apparatus” refers to an electronic computing apparatus including at least a processor and a memory, configured to execute software programs for managing data acquisition, storage, analysis, and communication.

The term “information reading device” refers to a hardware device configured to obtain identification information or position information of an object, including but not limited to a tag reader, a sensor module, or a communication interface.

The term “identification information” refers to data that uniquely or semi-uniquely identifies an object, such as a code, label, tag identifier, or address that can be read by an information reading device.

The term “position information” refers to data indicating a physical or logical location of an object, including coordinates, area identifiers, zone identifiers, or device-based location identifiers associated with the object.

The term “position information data” refers to a data structure generated by the system that associates position information of an object with auxiliary data including time information, device information, or context information.

The term “time information” refers to data representing a time of occurrence of an event, such as a timestamp, date, or time interval, obtained from a clock or timekeeping mechanism. The term “installation position information” refers to data indicating a fixed or known location at which an information reading device is installed or a current location associated with a mobile information reading device.

The term “communication network” refers to a wired or wireless communication infrastructure, such as a local area network, a wide area network, or a mobile communication network, used for transmitting data between components of the system.

The term “history information” refers to accumulated data representing past states or events related to objects, including previous position information, movement events, and associated timestamps.

The term “current position information” refers to data indicating the most recently known position of an object within the system, derived from latest position information data. The term “movement history information” refers to data representing a chronological sequence of changes in position of an object, including a series of locations and corresponding times.

The term “extraction condition” refers to a set of rules, constraints, or parameters used by the processor to select or filter history information or other stored data for analysis.

The term “structured data” refers to data formatted according to a predefined schema, such as key-value pairs, tables, or records, suitable for processing by software components. The term “operation condition information” refers to data representing constraints or parameters related to operations, such as work schedules, resource availability, priority rules, or service level requirements.

The term “prompt sentence” refers to a sequence of natural-language text or a similar representation that specifies input data and instructions to be provided to a generative AI model for obtaining a prediction or generated output.

The term “natural language” refers to a human language, such as English or another human-readable language, used to express the prompt sentence and interpret the output of the generative AI model.

The term “generative AI model” refers to a machine-implemented information processing model, such as a neural network or other machine-learning model, configured to generate output data including text or structured information in response to input data including a prompt sentence.

The term “prediction information” refers to data output by the generative AI model, representing an estimated or forecasted future state, such as a future destination, a future movement time, or a future demand quantity.

The term “future destination” refers to a predicted location to which an object is likely to move within a specified time period.

The term “future movement time” refers to a predicted time or time window at which an object is expected to move or arrive at a particular location.

The term “future demand quantity” refers to a predicted amount or volume of objects or items required or likely to be consumed in a future period.

The term “task instruction information” refers to data specifying operational actions to be executed, including at least one of a start time, an execution order, and an assigned apparatus for a particular operation.

The term “start time” refers to a time or time window at which execution of a specified operation is scheduled to begin.

The term “execution order” refers to a sequence or priority arrangement defining in which order multiple operations or tasks are to be performed.

The term “assigned apparatus” refers to a device, machine, or terminal that is designated to carry out a particular operation or task.

The term “transfer operation” refers to an operation in which an object is moved from one location to another, such as loading, unloading, or internal relocation.

The term “storage operation” refers to an operation in which an object is placed into, maintained in, or removed from a storage location, such as a shelf, bin, or container.

The term “inventory replenishment operation” refers to an operation in which a quantity of objects is moved to a location to increase available stock, such as restocking a shelf from a storage area.

The term “information terminal” refers to an electronic device including at least a display or user interface and a communication interface, configured to receive task instruction information from the server and provide notifications to a user.

The term “display device” refers to a component of an information terminal that visually presents text, images, or symbols representing task instructions or system status.

The term “alarm device” refers to a component of an information terminal that generates audible, visual, or tactile alerts to notify a user of an event, such as a scheduled task or abnormal condition.

The term “worker” refers to a human operator who receives task instruction information from an information terminal and performs physical or logical operations on objects.

The term “operation input” refers to input data provided by a worker to an information terminal, such as confirmations, status changes, or annotations related to task execution.

The term “work result information” refers to data representing an actual execution state or outcome of a task, including completion time, success or failure, and related details, derived from operation input or acquired position information data.

The term “evaluation data” refers to data used for assessing performance of predictions or operations, including work result information and movement history information, which may be used to compute prediction error or adjust system parameters.

The term “prediction error” refers to a measure representing a difference between prediction information and actual results, such as a time difference, a position difference, or a quantity difference.

The term “usage conditions” refers to operational parameters related to how the generative AI model is invoked, such as input composition, frequency of calls, or model configuration settings.

The term “time-series movement history information” refers to movement history information arranged or indexed in temporal order, allowing analysis of trends or patterns over time.

The term “inventory information” refers to data indicating quantities, locations, and statuses of stored items or objects within the system.

The term “sales history information” refers to data representing past transactions or consumption events related to items, including quantities sold and associated timestamps.

The term “description sentence” refers to a portion of a prompt sentence that describes data, context, or conditions provided to the generative AI model.

The term “instruction sentence” refers to a portion of a prompt sentence that explicitly specifies a requested prediction task, constraints, or an output format for the generative AI model.

The term “composition of the description sentence and the instruction sentence” refers to an arrangement, combination, or structure of descriptive content and directive content forming the overall prompt sentence.

The term “period of history information” refers to a time span, such as a number of days or months, over which history information is selected and included in the prompt sentence.

The term “item of history information” refers to a type or field of data within history information, such as a location field, a timestamp field, a quantity field, or a status field.

The term “weight of history information” refers to a parameter indicating a relative importance or influence assigned to particular portions or types of history information when generating or adjusting a prompt sentence.

In the following embodiments, a server, a terminal, and a user cooperate to implement the claimed system. The server executes software components on general-purpose hardware, and the terminal executes client software on mobile or fixed hardware, such as an industrial handheld device, a vehicle-mounted device, or a shelf-mounted embedded device.

### A. Overall Configuration of Hardware and Software

The server uses a computing platform including at least one processor, a main memory, a non-volatile storage device, and a network interface. The server executes an operating system such as a general-purpose server operating system and a middleware stack including a web application framework, a database management system, and a machine learning runtime. By way of example, the server uses a relational database management system such as PostgreSQL or MySQL to store normalized position information data and movement history information. The server optionally uses a machine learning framework such as a tensor computation library to implement and serve a generative AI model.

The terminal uses a computing platform including a processor, a memory, a display, a user input device (such as a touchscreen or buttons), and an information reading device. The information reading device is realized by an RFID reader module or another tag reader module, connected to the terminal via a serial interface, a USB interface, or a wireless interface. The terminal executes an operating system such as a mobile operating system or an embedded operating system, and an application that controls the information reading device, communicates with the server, and interacts with the user.

The user operates the terminal in a warehouse, a store, or another physical environment where objects provided with identification information are stored or transported. The user views task instruction information displayed on the terminal and performs corresponding physical operations on the objects.

### B. Data Structures and Storage Format

The server uses explicit data structures to represent position information data and related information. The server defines a movement history table that includes, for each record, fields such as an object identifier, a source location identifier, a destination location identifier, a detection time, a terminal identifier, and a status flag. The server defines a current position table that includes, for each object, a current location identifier and a last update time. The server defines a work result table that includes, for each task instruction, a task identifier, an execution start time, an execution completion time, and a result code. These tables are implemented as relational tables in the database.

The server also defines an internal representation of structured data that is passed to the generative AI model. For example, the server uses an ordered list of records where each record includes at least a timestamp, a location identifier, an operation type, and an item quantity. By storing such data in normalized form and in indexed tables, the server reduces redundant storage and enables efficient querying, which leads to improved processing speed when supplying data to the generative AI model and when updating current position information.

### C. Implementation of the Generative AI Model

The server implements the generative AI model as a neural network having a sequence-to-sequence architecture. In one embodiment, the server uses a transformer-based architecture including an embedding layer, a plurality of self-attention layers, and a feed-forward network. The server uses token embeddings to represent components of the prompt sentence, including textual descriptions of movement histories and operation conditions. The server uses positional encodings to represent temporal order in the time-series movement history information.

The server trains the generative AI model in advance using supervised learning. During training, the server supplies training inputs including synthetic or historical prompt sentences and ground-truth outputs including next location predictions, next time-window predictions, and demand quantity forecasts. The server minimizes a loss function that is a weighted combination of a cross-entropy term for categorical predictions of locations and a mean squared error term for numerical predictions of times and quantities. The server updates the weights of the neural network using a gradient-based optimization algorithm, such as stochastic gradient descent with momentum or an adaptive learning-rate method. The server optionally applies data augmentation techniques during training by randomly subsampling movement history sequences, adding noise to timestamps, or shuffling non-critical segments within allowed temporal windows. Such augmentation improves robustness of the model to incomplete or noisy data. The server may also train the model to output a confidence score by mapping an internal logit or hidden activation through a calibrated sigmoid function, which allows the server to estimate prediction certainty and adjust downstream scheduling decisions.

### D. Construction and Adaptation of the Prompt Sentence

The server generates a prompt sentence in natural language using a rule-based composition module. The server first queries the database to obtain time-series movement history information, inventory information, and sales history information for a given object or item category. The server then converts these records into a textual description that preserves temporal ordering and key attributes.

By way of example, the server generates a prompt sentence such as:

“You are a logistics planning assistant. The following is the movement history of item X for the last 30 days in chronological order. Each line has the format: time, from_location, to_location, quantity.
2026-01-01T10: 00:00Z, Receiving_Dock, Shelf_A_01, 10
2026-01-05T09: 30:00Z, Shelf_A_01, Picking_Zone_02, 5
2026-01-05T10: 00:00Z, Picking_Zone_02, Shipping_Dock_01, 5

Based on this history and typical warehouse operations, predict the most likely next destination and the expected departure time from the current location. Return the answer in the following text format:
next_location: [location]
estimated_departure_time: [ISO-8601 time]
confidence: [0 to 1]”

In another example, the server generates a prompt sentence such as:

“You are a demand forecasting assistant. The following table shows daily sales for item Y in Store_12 for the last 60 days. Each line has the format: date, sold_units.
2026 Jan. 1, 12
2026 Jan. 2, 15
2026 Jan. 3, 8

Based on this history, predict the expected daily demand for the next 7 days and propose a recommended shelf stock level to avoid stock-outs with 95 percent confidence. Return the result in the following text format:
date: [date], predicted_demand: [units], recommended_shelf_stock: [units]”

The server composes the description sentence and the instruction sentence according to a template stored in the memory. The server changes the length of the included time period, the selection of fields, and the explicit instructions based on recorded prediction error and work result information. For instance, when the server determines that predictions are consistently late for a particular operation type, the server modifies the prompt sentence to emphasize historical delays and to request explicit output of a loading start time prior to departure.

By programmatically adapting the prompt sentence, the server improves the utilization of the generative AI model and reduces the need for ad-hoc correction logic in downstream modules. This adaptive prompt generation is not a mere automation of human query writing but a technical mechanism for dynamically shaping model input to optimize model performance.

### E. Prediction Information Generation and Technical Improvement

The server supplies the generated prompt sentence to the generative AI model as a sequence of tokens. The server encodes the text using a tokenizer that converts characters or subwords into indices. The server executes the forward pass of the neural network to compute output tokens that correspond to predicted locations, times, and quantities, encoded as text. The server decodes these tokens into a textual response and parses the response according to the expected format.

The server uses deterministic or constrained decoding methods, such as beam search with limited beam width and restricted vocabularies for location identifiers and date formats. By constraining the output space in this way, the server reduces parsing errors and increases computational efficiency, because the model avoids exploring unlikely output sequences. The server thereby improves prediction quality and reduces the burden on downstream processing. The server compares the prediction information against actual work result information and movement history information to compute a prediction error. For time predictions, the server computes an absolute difference between estimated departure times and actual departure times. For location predictions, the server computes a categorical error by checking whether the predicted destination matches the actual destination. For quantity predictions, the server computes an absolute or relative difference.

The server records the prediction error in a performance log and uses it to update parameters of the prompt generation module. For example, when the server finds that prediction error increases when only seven days of history are included, the server automatically increases the period of history information to thirty days in subsequent prompt sentences. The server may also adjust weights assigned to different items of history information, increasing the emphasis on recent events or on particular operation types that have higher predictive value. This feedback-based adjustment improves technical performance of the prediction subsystem by reducing prediction error over time.

### F. Task Instruction Computation and Communication Optimization

The server converts prediction information into task instruction information. The server computes specific start times by subtracting estimated operation durations from predicted departure times. The server uses algorithmic scheduling methods, such as priority queues and heuristic search, to assign tasks to available terminals or apparatus. The server takes into account device capabilities, current workloads, and spatial adjacency of locations.

The server represents task instruction information in a compact data structure containing the task identifier, target object identifier, target location identifier, scheduled start time, deadline time, and assigned terminal identifier. By using such compact representations, the server reduces the amount of data transmitted to the terminals via the communication network, thereby reducing communication load and latency.

The terminal receives the task instruction information and stores it in local memory. The terminal uses an internal scheduler to trigger alerts at the scheduled times. The terminal uses hardware features such as a display, a speaker, and a vibration motor to notify the user. This configuration allows the system to control actual physical operations in the real world, such as loading, unloading, and replenishment, based on the outputs of the generative AI model.

### G. Execution Feedback and Closed-Loop Improvement

The user performs the instructed operations in the physical environment. The user then provides operation input to the terminal, such as pressing a completion button or scanning the object again with the information reading device. The terminal generates work result information that includes actual start and completion times and actual locations. The terminal transmits this work result information back to the server.

The server writes the received work result information into the work result table and updates both the current position table and the movement history table. The server uses the updated movement history information for future analyses and for constructing later prompt sentences. This closed loop ensures that the system not only uses the generative AI model for prediction but also continuously updates its internal data structures and prompt generation rules based on actual execution outcomes.

Because the server adjusts its internal prompt generation and scheduling logic using objective prediction error metrics and execution logs, the system improves computer-implemented prediction accuracy and scheduling efficiency over time. The technical effect includes reduced overall processing time for generating viable task plans, reduced number of rescheduled tasks due to inaccurate predictions, and lower network utilization due to more compact data exchanges and fewer corrective messages.

### H. Differentiation from Conventional Human-Centric Processes

The described system does not merely automate a human dispatcher's planning behavior. The server performs computer-specific operations that would be impractical or infeasible for a human to perform at scale, such as dynamically constructing and updating large prompt sentences based on millions of historical records, computing error statistics over extensive datasets, and adapting input composition to a neural network using precise quantitative criteria. The generative AI model operates according to internal weights and activation patterns that capture complex temporal and spatial dependencies in the data, which are not explicitly encoded as human-readable rules.

The server's adaptive control of prompt sentences and scheduling parameters constitutes an improvement in computer technology, because it changes how the computer organizes and processes data within memory, how it allocates processing resources for inference and communication, and how it interacts with a large-scale neural network to minimize prediction error and operational latency.

### I. Alternative embodiments and variations

In one embodiment, the server integrates the generative AI model as a local module running on a graphics processing unit. In another embodiment, the server accesses the generative AI model through an external inference service via an application programming interface. In either case, the server maintains control over prompt generation and error-based adaptation. In one embodiment, the terminal uses a handheld device with an integrated RFID reader to acquire identification information. In another embodiment, the terminal is a fixed device mounted on a shelf or a vehicle-mounted device on a forklift or truck. In each case, the terminal executes similar client software that communicates with the server and presents task instruction information.

In one embodiment, the movement history information includes only location and time fields. In another embodiment, the movement history information further includes environmental sensor readings, such as temperature or humidity, and the server extends the prompt sentence to include such readings in the description sentence. The same adaptive mechanism applies: when the server detects that such environmental data contributes to prediction accuracy, the server increases its representation in the prompt sentence.

In one embodiment, the generative AI model uses a transformer architecture. In another embodiment, the generative AI model uses a recurrent neural network or a hybrid model combining a convolutional layer and an attention-based layer. The training procedures and feedback loops are analogous, and the system still uses prediction error to adjust the composition of the prompt sentence and the usage conditions of the model.

Through these embodiments and variations, the server and the terminal implement a concrete computer-based system that controls physical operations and improves internal data handling and prediction mechanisms, thereby achieving technical effects such as improved processing speed, reduced prediction error, improved data management, enhanced computational efficiency, and reduced communication load.

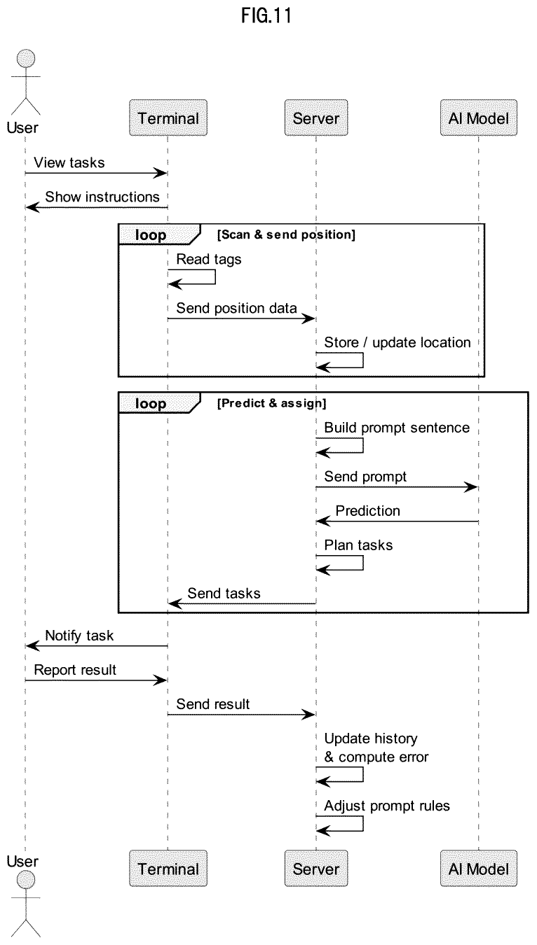

The following describes the processing flow using FIG. 11.

### Step 1:

Terminal controls an information reading device to acquire raw tag data.

Terminal uses a reader driver to send a scan command to the information reading device and receives a set of tag identifiers and signal parameters (for example, RSSI, antenna ID).

Input: low-level reader events (scan trigger, reader configuration) and environment context (terminal ID, installation position, system time).

Processing: Terminal associates each detected tag identifier with the terminal ID, the current timestamp from the system clock, and installation position information stored in local configuration. Terminal may also filter duplicate detections within a short time window by comparing tag identifiers and timestamps.

Output: Terminal generates position information data records, each including at least an object identifier, a detection time, and a terminal identifier, and stores these records in a local buffer.

### Step 2:

Terminal transmits position information data to the server over a communication network.

Input: buffered position information data records including object identifiers, detection times, and terminal identifiers.

Processing: Terminal serializes the records into a structured message, attaches authentication information, and opens a network connection to the server endpoint. Terminal performs basic compression or batching by grouping multiple records into a single message to reduce communication overhead.

Output: Terminal sends the structured message to the server and receives an acknowledgment message; Terminal marks successfully transmitted records as sent and clears them from the local buffer.

### Step 3:

Server receives, validates, and normalizes the transmitted position information data.

Input: structured messages from multiple terminals containing position information data records.

Processing: Server parses each message, checks field formats (identifier length, timestamp format), and discards or flags invalid entries. Server resolves each terminal identifier to a logical location identifier using a configuration table. Server then constructs normalized movement events with fields such as object ID, logical location, detection time, and source terminal.

Output: Server produces a list of normalized movement events ready for storage and further analysis.

### Step 4:

Server stores movement events as history information and updates current position information.

Input: normalized movement events containing object IDs, logical locations, and detection times.

Processing: Server inserts each movement event into a movement history table, indexing by object ID and time. Server queries the current position table for each object ID; if an entry exists, server sets the previous location as the “from_location” and the new logical location as the “to_location,” and updates the current position and last update time. If no entry exists, server creates a new current position record.

Output: Server maintains an updated movement history table and a current position table that together represent movement history information and current position information for all objects.

### Step 5:

Server selects analysis targets and extracts history information for prediction.

Input: current position information, movement history information, and operation condition information such as planning horizon, target objects, or item categories.

Processing: Server identifies objects or items requiring prediction, for example all objects scheduled for outbound movement within a certain time window. Server executes database queries to extract time-series records for each target, including recent movements and optionally related inventory and sales histories. Server orders the records chronologically and groups them per object or item category.

Output: Server generates structured history datasets, each associated with a prediction task and formatted as ordered sequences suitable for textual conversion.

### Step 6:

Server converts structured history datasets into descriptive text segments.

Input: structured history datasets containing time-ordered movement, inventory, and sales records.

Processing: Server maps internal field names (for example, location IDs, operation types, quantities) to human-readable labels, formats timestamps into a consistent textual form, and creates lines of text where each line corresponds to one record. Server concatenates these lines with explanatory headers that describe the format (for example, “time, from_location, to_location, quantity”).

Output: Server produces descriptive text segments representing the history information in natural-language-readable form.

### Step 7:

Server constructs a prompt sentence by combining description and instruction sentences.

Input: descriptive text segments and operation condition information such as desired prediction type and output format.

Processing: Server inserts the descriptive text segments into a prompt template that includes a role description and an instruction section. For example, Server prepends a role explanation (“You are a logistics planning assistant”) and appends clear instructions about the requested prediction and output structure. Server adjusts the length of the history section, selection of fields, and specific wording based on stored prediction error statistics and work result information.

Output: Server generates a complete prompt sentence in natural language, ready to be supplied to the generative AI model.

### Step 8:

Server encodes and sends the prompt sentence to the generative AI model.

Input: prompt sentence text and model usage conditions such as decoding strategy, maximum length, and temperature parameter.

Processing: Server tokenizes the prompt sentence into a sequence of tokens using a predefined tokenizer. Server sends the token sequence and associated parameters to the generative AI model via a machine learning runtime or an external inference service.

Output: Server receives, from the generative AI model, an output token sequence representing the model's generated text response.

### Step 9:

Server decodes and parses the response from the generative AI model into prediction information.

Input: output token sequence generated by the generative AI model.

Processing: Server converts tokens back into text and searches for key labels such as “next_location:”, “estimated_departure_time:”, “confidence:”, “predicted_demand:”, and “recommended_shelf_stock:”. Server extracts the associated values, validates their formats (for example, time strings or numeric ranges), and converts them to internal representations such as timestamps, location identifiers, and numeric quantities.

Output: Server generates structured prediction information records linking each prediction to the corresponding object or item and storing them in a prediction information table.

### Step 10:

Server computes task instruction information based on prediction information and system constraints.

Input: prediction information records, current position information, and operation condition information including device capabilities, operation durations, and deadlines.

Processing: Server calculates start times for transfer, storage, or inventory replenishment operations by subtracting estimated durations from predicted departure or demand times. Server uses scheduling algorithms to order tasks and assign them to specific terminals or apparatus based on proximity, availability, and load balancing criteria. Server constructs task instruction records that specify, for each task, the object ID, target location, start time, deadline, priority, and assigned terminal.

Output: Server stores task instruction information in a task instruction table and marks each task as pending distribution.

### Step 11:

Server distributes task instruction information to terminals and optimizes communication.

Input: pending task instruction records and terminal connectivity status.

Processing: Server groups instructions per terminal and removes redundant information by using compact identifiers and references instead of full descriptions. Server sends instruction messages over the communication network and implements retry and acknowledgment mechanisms to ensure reliable delivery. Server updates task status to “dispatched” upon successful transmission.

Output: Terminals receive task instruction messages associated with their identifiers, and the server maintains an updated record of dispatched tasks.

### Step 12:

Terminal presents task instructions and issues alerts to the user.

Input: task instruction messages received from the server and local time information from the terminal.

Processing: Terminal stores the instructions locally and registers timers for scheduled start times and deadlines. Terminal generates visual representations of tasks on the display, including task descriptions, locations, and scheduled times. As a scheduled time approaches, Terminal triggers hardware alerts such as sound, vibration, or flashing indicators to attract the user's attention.

Output: Terminal shows active tasks to the user and produces user-perceivable alerts at appropriate times.

### Step 13:

User performs operations and inputs execution status through the terminal.

Input: displayed task instructions and physical access to objects and equipment in the environment.

Processing: User uses the instructions to locate the objects, move or store them as instructed, and then interacts with the terminal to report progress. User may press buttons such as “Start” and “Complete,” enter comments, or rescan the object's identifier using the information reading device to confirm execution.

Output: Terminal obtains operation input events and scanned tag data that together represent work result information, including actual start and completion times and actual locations.

### Step 14:

Terminal sends work result information to the server.

Input: locally recorded work result information for completed or updated tasks.

Processing: Terminal packages task identifiers, timestamps, result codes, and any scanned identifiers into structured messages. Terminal transmits these messages to the server using the same or similar communication channel as for position information data. Terminal logs transmission status and, if necessary, retries failed transmissions.

Output: Server receives structured work result messages for incorporation into central records.

### Step 15:

Server updates movement history and current position based on work result information.

Input: work result messages including task identifiers, actual times, and possibly newly scanned object positions.

Processing: Server matches each work result to the corresponding task instruction record and updates its status to “completed” or another appropriate state. If the work result includes new position information, Server inserts new movement events into the movement history table and updates current position records. Server also records the relation between predicted times and actual completion times for later analysis.

Output: Server maintains consistent movement history information, current position information, and task execution records reflecting actual operations.

### Step 16:

Server computes prediction error and adapts future prompt sentences and usage conditions.

Input: prediction information records, corresponding work result information, and movement history information reflecting actual outcomes.

Processing: Server calculates error metrics such as differences between predicted departure times and actual departure times, mismatch rates between predicted and actual destinations, and differences between predicted and actual demand quantities. Server aggregates these metrics across tasks and time periods. Based on these metrics, Server adjusts parameters of the prompt generation module, including the period of history information to include, the items of history information to emphasize, and relative weights for recent versus older data. Server may also modify usage conditions of the generative AI model, such as the maximum prompt length or decoding constraints.

Output: Server updates configuration data for prompt sentence composition and model invocation, leading to modified prompt sentences and improved technical performance in subsequent prediction and scheduling cycles.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional inventory management and logistics systems that rely on radio frequency identification technology and centralized databases primarily perform rule-based updates of stock levels and locations. In such systems, a processor typically stores position information received from readers and applies fixed threshold rules or simple statistical models to trigger replenishment or relocation. These approaches suffer from several technical problems in terms of computer technology.

First, conventional systems do not tightly integrate time-series position information and heterogeneous historical data such as sales records and shipment records into a unified, machine-interpretable representation that can be directly consumed by an advanced prediction engine. As a result, a processor must execute multiple ad hoc queries and conversions for each forecasting cycle, leading to fragmented data flows, redundant computations, and increased processing latency. This degrades overall system responsiveness and scalability, particularly when handling a large number of objects and high-frequency RFID scans.

Second, conventional systems do not use a generative AI model in a structured and repeatable manner for forecasting. When a prediction engine is used at all, it is often a fixed, narrowly trained model bound to a specific data schema, which limits flexibility when data distributions, item categories, or business requirements change. In particular, known systems do not systematically construct and manage prompt sentences that encode feature data into natural language or table formats suitable for a generative AI model, nor do they maintain a closed feedback loop between model outputs and subsequent prompt construction. Consequently, the processor cannot efficiently adapt to changing patterns, and the accuracy and robustness of forecasting remain limited.

Third, existing architectures typically separate predictive computation from operational instruction generation. Forecast results, if available, must be manually inspected or post-processed by additional external tools before operational tasks such as robot dispatch, worker guidance, and automated ordering can be determined. This separation forces the processor to perform multiple disjoint pipelines: one for data collection, one for prediction, and one for workflow generation. Such fragmentation increases inter-module communication overhead, introduces synchronization errors between inventory state and forecast state, and complicates fault handling and recovery within the computing system.

Fourth, conventional inventory systems lack an integrated mechanism to use execution feedback (for example, task completion reports, corrections from workers, or discrepancies between planned and actual movements) to update both the persistent historical information and the inputs used for subsequent forecasting. As a result, errors in sensing, mis-picks, or delayed operations are not promptly reflected in the internal data structures used for prediction. This leads to cumulative drift between the real-world state and the internal machine representation, degrading the quality of predictions and causing the processor to generate suboptimal or conflicting instructions.

Accordingly, there is a need for an improved computer-implemented system in which a processor: (i) acquires RFID-based position information and historical transaction information, (ii) generates feature data and constructs structured prompt sentences to be input to a generative AI model, (iii) obtains from the generative AI model demand forecast information and inventory shortage risk information, and (iv) directly converts such information into work instruction information and ordering information. There is also a need for a system in which the processor uses feedback from terminal devices to update stored inventory states and historical information, and to refine subsequent prompt construction and forecasting in a closed loop. Such a system would improve the technical functioning of the computerized inventory platform by reducing processing latency, improving forecast accuracy, and enabling more consistent and automated control of robotic apparatuses and terminal devices.

The specific processing by the specific processing unit 290 of the data processing device 12 in Application Example 1 is realized by the following means.

The present invention provides a server comprising a processor configured to acquire, via a communication interface, position information of objects from a wireless identification device, to store the position information and historical information including sales information and shipment information in a storage device in a time-series structure, to generate feature data of inventory amounts and demand from the position information and the historical information, to construct a prompt sentence for a generative AI model by converting the feature data into a natural language format or a table format, to transmit input data including the prompt sentence to the generative AI model and obtain demand forecast information and inventory shortage risk information from the generative AI model, to calculate, based on the demand forecast information and a current inventory state, a replenishment amount, a relocation amount, and an ordering time for each object and to generate work instruction information for a robotic apparatus, an information terminal apparatus, and a supply apparatus, and to receive, from the information terminal apparatus, work completion information and correction information, to update the inventory state and the historical information in the storage device based on the work completion information and the correction information, and to use an update result for generation of a subsequent prompt sentence and for subsequent demand forecasting processing. This enables the computing system to implement an integrated and adaptive inventory management loop in which data acquisition, AI-based forecasting, and operational instruction generation are tightly coupled within the processor, thereby reducing processing overhead, improving forecast accuracy and responsiveness, and enhancing the efficiency and reliability of automated control over robotic devices, terminal devices, and electronic ordering processes.

The term “processor” refers to one or more hardware processing units, such as a central processing unit, a microcontroller, or any combination of hardware logic circuits, configured to execute computer-readable instructions to perform the described functions.

The term “wireless identification device” refers to an apparatus configured to communicate with identification media using wireless signals, such as a reader that transmits and receives radio frequency signals to interact with identification tags.

The term “identification media” refers to one or more physical carriers that store identification information and that are configured to be read by a wireless identification device, such as radio frequency identification tags or similar electronic labels.

The term “position information” refers to data indicating a location of an object in a monitored area, including at least one of a shelf identifier, a zone identifier, a vehicle identifier, or spatial coordinates, optionally associated with a time stamp.

The term “object” refers to any managed item, article, unit of inventory, or physical entity whose position, quantity, or movement is tracked by the system.

The term “storage unit” refers to one or more memory devices or storage devices, such as a database system or a non-volatile memory, configured to store position information, historical information, and other related data.

The term “historical information” refers to time-series data associated with past states or events relating to objects, including at least one of past position information, sales information, shipment information, movement histories, and previous inventory states.

The term “inventory state” refers to data indicating a current quantity, location, availability, or other status of objects managed by the system at a particular time.

The term “movement history” refers to a record of changes of location or status of an object over time, including information about when and where the object was moved or handled.

The term “feature data” refers to derived numerical or categorical values computed from position information and historical information, which represent characteristics of inventory amounts, demand patterns, or movement patterns and are used as input for prediction or analysis.

The term “prompt sentence” refers to a text expression, including one or more natural language sentences or table-like textual structures, constructed so as to instruct a generative AI model to perform a specific computation or prediction based on embedded or referenced feature data.

The term “generative AI model” refers to a machine-implemented model, such as a neural network-based language model, configured to generate output data including text or structured values in response to an input that includes a prompt sentence, and to produce at least demand forecast information and inventory shortage risk information.

The term “input data including the prompt sentence” refers to data transmitted to the generative AI model, comprising at least the prompt sentence and optionally additional contextual or structured data that the generative AI model uses to generate an output.

The term “demand forecast information” refers to data indicating a predicted demand for objects over a future period, including at least one of predicted quantities, temporal demand profiles, and anticipated peak periods.

The term “inventory shortage risk information” refers to data indicating a likelihood or risk level that an inventory amount of an object will fall below a predetermined threshold, such as a safety stock level, within a future time period.

The term “replenishment amount” refers to a computed quantity of an object that should be added to inventory, such as by ordering or transferring, to satisfy predicted demand and maintain a desired inventory state.

The term “relocation amount” refers to a computed quantity of an object that should be moved from one location to another within the managed environment to optimize availability, picking efficiency, or capacity utilization.

The term “ordering time” refers to a computed time or time period at which a request for additional objects should be issued to a supplier or source to achieve a desired future inventory state.

The term “work instruction information” refers to data describing operational actions to be performed by devices or users, including at least one of pick tasks, move tasks, packing tasks, and replenishment tasks, and specifying objects, quantities, locations, and timings.

The term “robotic apparatus” refers to one or more automated machines, such as mobile robots, robotic arms, or automated guided vehicles, configured to execute physical operations including picking, moving, or transporting objects based on received control instructions.

The term “information terminal apparatus” refers to an electronic device having at least a processor, a display, and a communication interface, such as a handheld terminal, a mobile device, or a workstation, configured to present information to a user and to transmit user inputs to the server.

The term “supply apparatus” refers to an electronic system associated with a supplier, external system, or ordering platform, which is configured to receive electronic ordering information and to process supply of objects.

The term “electronic ordering information” refers to data representing an order request for objects, including at least identifiers, quantities, and desired delivery times, formatted for electronic transmission to a supply apparatus.

The term “work completion information” refers to data transmitted from an information terminal apparatus indicating that at least a portion of one or more work instructions has been executed, including identification of tasks, completion status, and optionally actual handled quantities.

The term “correction information” refers to data indicating modifications, overrides, or adjustments to previously stored or planned information, such as corrections to item counts, locations, task results, or forecast-based plans, provided from an information terminal apparatus.

The term “update result” refers to a state of stored data, including the inventory state and historical information, after applying work completion information and correction information, which is used as a basis for subsequent processing, including generation of a subsequent prompt sentence and demand forecasting.

In one embodiment, a server, one or more terminals, and one or more robotic apparatuses cooperate to implement the claimed system. The server includes at least one processor, a main memory, a non-volatile storage device, and a network interface. The terminals each include at least one processor, a memory, a display, a user input interface, a wireless communication interface, and a wireless identification device such as an RFID reader. The robotic apparatus includes a controller, drive units, a wireless communication interface, and one or more actuators for moving and picking objects.

The server executes an inventory management program stored in the non-volatile storage device. The terminal executes a client program stored in a local storage unit. The server program and the client program are implemented, for example, using general-purpose operating systems and application frameworks such as a server operating system, a web application framework, and a mobile operating system framework. The specific product names disclosed previously, such as particular RFID reader models or application frameworks, can be replaced with any equivalent hardware or software components that provide comparable functions.

The terminal controls the wireless identification device to acquire identification information from identification media attached to physical objects. The terminal uses driver software and firmware supplied for the wireless identification device to cause the device to emit radio frequency signals, receive backscattered signals from identification media, and decode the signals into tag identifiers and sensor metadata. The terminal associates each tag identifier with locally available context information, such as a device identifier, a zone code, or a vehicle position determined from a positioning sensor, and generates position information records. The terminal stores these records temporarily in a local buffer, converts them to a structured format, and transmits them to the server via a wireless communication protocol. The server receives the position information records via the network interface and stores them into a storage device that provides database functionality. The server organizes the position information in a time-series structure, for example as records indexed by object identifier and timestamp, and maintains a movement history for each object. The server also receives and stores historical information, including sales information, shipment information, and previous inventory states, from external systems or from manual input via the terminals. By managing these different kinds of information in a unified storage structure, the server enables the processor to access related records by indexed queries that minimize disk seeks and reduce memory usage.

The server performs data processing to generate feature data used for forecasting. The server program includes a data processing module that executes numerical and categorical transformations on the stored position information and historical information. The server, for example, aggregates daily sales counts per object, computes moving averages over multiple time windows, extracts seasonality patterns by comparing corresponding days of multiple weeks, and calculates time intervals between restocking events. The server also derives features from movement histories, such as average dwell time at a shelf, frequency of relocation, and correlation between position and sales. The server stores these feature values in intermediate data structures, such as columnar tables or in-memory arrays, and normalizes or scales the features as needed.

The server constructs a prompt sentence for a generative AI model based on the feature data. The server assembles multiple components of text, including descriptive instructions, embedded numeric values, and tabular summaries, into a single text sequence. The server converts feature values into human-readable forms, such as:
“Item ID: X123, Daily sales for last 30 days: 10, 13, 9, 11, 14, . . .
Current on-hand inventory: 250 units
Lead time from supplier: 5 days”
and appends these lines to an instruction block, such as:
“You are a generative AI model acting as an inventory demand forecasting assistant.

Based on the following historical sales data and current inventory amounts, predict the daily demand for each item for the next 30 days and estimate the risk of inventory shortage.

Return a list with, for each item: item ID, predicted daily demand, probability of shortage (0 to 1), and recommended safety stock level.”

The server generates different prompt sentences for different objects or groups of objects, or for different forecast horizons. By constructing the prompt sentences algorithmically using feature data and templates, the server transforms raw database records into a compact and context-rich textual representation that can be processed efficiently by the generative AI model.

The server uses a generative AI model that has a specific neural network architecture. In one embodiment, the generative AI model is a transformer-based language model that includes multiple layers of self-attention, feed-forward networks, and normalization operations. The model parameters are stored in a model storage device accessible to the server or to an external AI service. The server uses an application programming interface to send the constructed prompt sentence as a sequence of textual tokens to the generative AI model. The generative AI model internally transforms each token into a vector representation, applies multi-head attention to compute context-dependent embeddings, and propagates these embeddings through successive layers to generate output tokens that encode forecast information.

The generative AI model is trained in advance using a training dataset that includes pairs of input prompt sentences and desired outputs. During training, the model uses a loss function such as cross-entropy between predicted tokens and target tokens, and updates weights by gradient-based optimization such as stochastic gradient descent or an adaptive variant. The training process may also include data augmentation, such as rephrasing instruction text or injecting synthetic examples with varying demand patterns, to make the model robust to different prompt sentence formulations. As a result of such training, the generative AI model learns to map structured descriptions of historical data and instructions into accurate and structured forecast outputs.

The server specifies model parameters for each inference call, such as a temperature parameter controlling randomness, a maximum number of output tokens, and an instruction to align the output format with a desired schema. This explicit control of model parameters allows the server to optimize computational workload and output consistency. The server logs each prompt sentence and each corresponding response, together with a model version identifier, so that later processing can analyze the relationship between input structure, model behavior, and forecast accuracy.

The server receives a textual output from the generative AI model. The output contains, for example, lines like:
“Item ID: X123
Predicted average daily demand (next 30 days): 18 units
Probability of inventory shortage within 14 days: 0.25
Recommended safety stock: 90 units”

The server parses the output by pattern-matching and text segmentation, extracts numeric values from the text, and validates them against basic constraints. The server then stores these extracted values as demand forecast information and inventory shortage risk information in the storage device. By combining the prompt-construction procedure with the parsing procedure, the server creates a closed data flow from stored numerical features to forecast parameters and back into machine-readable structured data.

The server calculates a replenishment amount, a relocation amount, and an ordering time for each object based on the forecast information and the current inventory state. The server uses deterministic algorithms, such as a reorder point calculation that compares predicted cumulative demand until the next possible delivery date with the current inventory plus expected incoming shipments. The server computes, for each object, a target stock level equal to predicted demand over a coverage period plus a safety stock level provided or suggested by the generative AI model. The replenishment amount is derived as the difference between the target stock level and the expected stock at the end of the coverage period. For relocation, the server compares the distribution of stock across storage zones with a desired distribution that minimizes average picking distance or balances load across zones. The server uses optimization methods, such as linear programming or heuristic search, to compute relocation amounts that move objects from surplus zones to deficit zones within physical capacity constraints.

The server generates work instruction information for one or more robotic apparatuses and as display content for one or more terminals. For a robotic apparatus, the work instruction information includes object identifiers, source locations, destination locations, quantities, and a temporal order of operations. The server translates this information into control messages defined by a robot control protocol. For a terminal, the work instruction information is formatted for human readability and may include shelf identifiers, object images, and step-by-step guidance. The terminal displays a list of tasks to the user and provides interaction widgets to mark tasks as started, paused, or completed, and to input corrections such as missing items.

The terminal transmits work completion information and correction information back to the server when the user interacts with the display. The server receives these inputs, validates them, and updates the inventory state and historical information accordingly. The server, for example, decreases inventory at a source location when a pick task is reported as completed, increases inventory at a destination location when a relocation task is completed, and records exceptions when the reported quantities differ from the planned quantities. The server then inserts new records into the movement history, so that subsequent feature generation and prompt construction use corrected data rather than relying solely on predictions.

By integrating the generative AI model into this closed loop, the server improves computer technology in several ways. First, the construction and reuse of prompt sentences based on feature data reduces the amount of raw data that must be transmitted to or processed by the generative AI model. The server compresses high-dimensional time-series into aggregated textual descriptions, which shortens prompt length and reduces computational cost for the model. This enables faster response times and lower processing loads on the AI hardware. Second, the server's use of structured feature generation and validation before and after the AI inference improves forecast accuracy and robustness. The server pre-processes data to remove noise, standardize time windows, and emphasize relevant patterns, which allows the generative AI model to focus its high-capacity computation on a concise and informative representation. The server also post-processes output values with domain-specific consistency checks, preventing invalid values from propagating into inventory plans. This combination of feature engineering, prompt design, and post-validation constitutes a technical improvement in the way the computing system uses AI for forecasting.

Third, the server directly uses AI outputs in machine-level planning algorithms to generate instructions for robotic apparatuses, rather than requiring human interpretation. The server converts forecast information into low-level control parameters, such as target positions and quantities, and issues these parameters in a format suitable for automated control loops in the robotic apparatus. This integration removes redundant human-in-the-loop steps and reduces end-to-end latency from sensing to actuation. The causal relationship between improved forecasting, optimized planning, and robot control results in fewer unnecessary movements, shorter travel paths, and more efficient utilization of physical resources.

Fourth, the server implements a feedback mechanism in which actual execution data and exception reports are fed back into the storage device and used to regenerate feature data and prompt sentences. As execution feedback accumulates, the server may adjust configuration parameters for prompt construction, such as selecting different time windows or emphasizing different feature types, based on empirically measured forecast errors. The server can also adapt model invocation parameters, such as requesting more conservative safety stock from the generative AI model when observed shortages exceed a threshold. This feedback loop reduces long-term systematic errors and drift, and leads to a measurable reduction in forecast error metrics and a corresponding improvement in inventory stability.

In another embodiment, the server uses a local generative AI model deployed on dedicated acceleration hardware such as a graphics processing unit or a tensor processing unit. The server schedules inference jobs to balance workload on the acceleration hardware and caches intermediate representations for similar prompt sentences. By co-locating data storage, feature processing, and AI inference within the same physical server or cluster, the system reduces network latency and communication overhead, thereby improving overall throughput.

In a further embodiment, the server supports multiple generative AI models with different sizes or training specializations. The server selects a particular model based on item category, forecast horizon, or current system load. For example, the server may use a compact model for high-frequency, short-term forecasts and a larger model for infrequent, long-range planning. The server maintains standardized prompt sentence templates but adjusts content density and level of detail per model, which enhances computational efficiency without sacrificing forecast quality.

The terminal can take different form factors, including a handheld device, a vehicle-mounted display, or a fixed workstation. In each case, the terminal executes substantially the same client program that receives work instruction information, presents human-readable guidance, and transmits user actions and RFID scan results to the server. By placing only limited logic on the terminal and centralizing feature processing and AI interaction on the server, the system simplifies terminal hardware requirements while allowing the server to perform complex computations and adapt behavior globally.

The user interacts with the terminal to execute tasks and correct anomalies. The user does not need to understand the internal operation of the generative AI model, because the server abstracts the AI behavior through consistent prompt sentence templates and structured outputs. The user's primary role is to physically handle objects and to confirm system actions, while the server continuously refines its internal data representation and prediction logic based on observed outcomes.

The described embodiments show that the system is not limited to abstract data processing, but is directly tied to control of physical equipment and management of physical inventory. The server's algorithms for feature generation, prompt construction, AI inference orchestration, and instruction generation are designed to exploit the capabilities of the generative AI model and the underlying hardware architecture to improve speed, accuracy, and reliability of the inventory management process. Through these mechanisms, the system achieves technical effects such as reduced computational load, improved data consistency, lower forecast error, and more efficient control of robotic apparatuses, which collectively represent an improvement in computer technology.

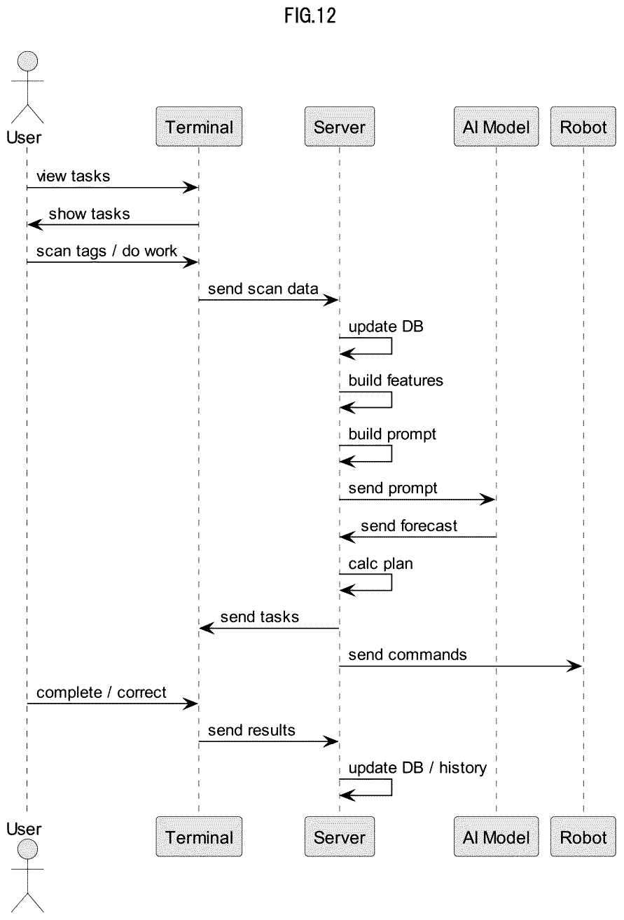

The following describes the processing flow using FIG. 12.

### Step 1:

The terminal controls the wireless identification device to acquire raw tag readings from identification media attached to objects.

The input to this step is a set of radio frequency signals received by the wireless identification device when the user brings the device near shelves, pallets, or containers.

The terminal uses firmware and driver software of the wireless identification device to demodulate the radio frequency signals, decode protocol frames, and extract tag identifiers, signal strength values, and read timestamps.

The terminal combines the decoded tag identifiers with locally available context data, such as terminal ID, current zone identifier, or vehicle position obtained from a positioning sensor, and generates position records for each object.

The output of this step is a buffered list of position records, each record including at least a tag identifier, a timestamp, a location identifier, and a terminal identifier.

### Step 2:

The terminal converts the buffered list of position records into a structured transmission payload and sends the payload to the server.

The input to this step is the list of position records produced in Step 1.

The terminal formats each record into a structured data representation, such as a delimited text line or a key-value map, and aggregates multiple records into a single payload while adding sequence numbers and error-checking codes.

The terminal establishes a network connection to the server via a wireless communication protocol, attaches authentication information, and transmits the payload to a designated endpoint.

The output of this step is a transmitted payload containing multiple position records delivered to the server.

### Step 3:

The server receives the transmitted payload and validates each position record before storing it.

The input to this step is the payload sent from the terminal in Step 2.

The server parses the payload into individual records, checks that mandatory fields such as tag identifier, timestamp, and location identifier are present, and verifies that timestamps fall within an acceptable range and that location identifiers correspond to registered locations in a configuration table.

The server discards or flags records that fail validation and logs error details, while marking valid records for insertion into persistent storage.

The output of this step is a filtered set of valid position records ready to be written into the storage device, along with a log of rejected records.

### Step 4:

The server updates the movement history and current inventory state tables based on the validated position records.

The input to this step is the set of valid position records produced in Step 3.

The server executes database operations to insert each position record into a movement history table indexed by object identifier and timestamp, and to update a current inventory table so that the latest location for each object is recorded and quantities are adjusted where necessary.

The server resolves conflicts when multiple locations are reported for the same object within a short time window by applying predetermined rules, such as prioritizing fixed readers over mobile readers or selecting the record with the newest timestamp.

The output of this step is an updated set of database tables that reflect current object locations and an extended movement history for subsequent analysis.

### Step 5:

The server generates feature data for each object by processing the movement history and historical transaction data.

The input to this step is the updated movement history, stored sales information, shipment information, and current inventory state tables.

The server executes aggregation queries and numerical computations to derive daily sales volumes, moving averages over multiple time windows, frequency of stock-outs, average lead times, and movement statistics such as average dwell time at each location.

The server normalizes these derived values, for example by scaling them to a fixed range or by computing z-scores, and stores them in feature data structures indexed by object identifier and time period.

The output of this step is a set of feature vectors or tables, each describing inventory and demand characteristics for a corresponding object.

### Step 6:

The server constructs a prompt sentence for a generative AI model using the generated feature data.

The input to this step is the set of feature vectors or tables produced in Step 5, together with pre-defined text templates that specify instructions to the generative AI model.

The server converts numerical feature values into human-readable text segments and tabular summaries, such as lines listing daily sales numbers, current inventory amounts, and lead times, and inserts these segments into template positions within an instruction text.

The server assembles the instruction text and the embedded feature summaries into a single continuous prompt sentence, including explicit instructions such as:

“You are a generative AI model acting as an inventory demand forecasting assistant.

Based on the following historical sales data and current inventory amounts, predict the daily demand for each item for the next 30 days and estimate the risk of inventory shortage.

Return a list with, for each item: item ID, predicted daily demand, probability of shortage (0 to 1), and recommended safety stock level.”

The output of this step is a complete prompt sentence, formatted as a text sequence, ready to be transmitted to the generative AI model.

### Step 7:

The server transmits the constructed prompt sentence to the generative AI model and obtains a textual forecast response.

The input to this step is the prompt sentence generated in Step 6 and model invocation parameters such as temperature and maximum output length.

The server converts the prompt sentence to an appropriate encoding, sends it through an application programming interface to the generative AI model, and waits for the model to process the input using its internal neural network layers.

The server receives the generated text output, which contains forecast values and risk assessments in a natural language or semi-structured format, and stores the raw text for logging and traceability.

The output of this step is a textual model response containing demand forecast information and inventory shortage risk information for the relevant objects.

### Step 8:

The server parses the textual response from the generative AI model and converts it into structured forecast records.

The input to this step is the model response text produced in Step 7.

The server applies pattern recognition rules, tokenization, and text segmentation to identify key fields such as item identifiers, predicted daily demand values, probabilities of shortage, and recommended safety stock levels, and converts these textual values into numeric or categorical data types.

The server validates the extracted values against logical constraints, for example by rejecting negative demand values or probabilities outside the range from zero to one, and discards or corrects inconsistent entries according to predefined rules.

The output of this step is a set of structured forecast records that represent demand forecast information and inventory shortage risk information for each object.

### Step 9:

The server calculates replenishment amounts, relocation amounts, and ordering times using the structured forecast records and the current inventory state.

The input to this step is the structured forecast records from Step 8 and the latest inventory state and movement constraints from the database.

The server computes, for each object, a target inventory level for a given planning horizon by combining predicted demand with the recommended safety stock, and then calculates a replenishment amount as the difference between the target level and the projected future inventory considering expected receipts.

The server analyzes stock distribution across locations to determine relocation amounts that rebalance inventory and reduce travel distances, and determines ordering times by comparing lead times with predicted depletion points so that new stock arrives before inventory falls below safety thresholds.

The output of this step is a planning dataset that specifies, per object and per location, the required replenishment quantities, relocation quantities, and recommended ordering times.

### Step 10:

The server generates work instruction information for robotic apparatuses and terminals based on the planning dataset.

The input to this step is the planning dataset produced in Step 9.

The server converts replenishment and relocation requirements into detailed tasks by assigning specific pick locations, drop locations, quantities, and task priorities, and groups these tasks into work orders tailored to robotic apparatuses and human workers.

The server formats robot-oriented tasks into control messages that specify routes and operation sequences, and formats worker-oriented tasks into human-readable descriptions, including shelf identifiers, item names, quantities, and suggested execution order.

The output of this step is a set of work instruction messages for robotic apparatuses and a set of task lists and display content for terminals.

### Step 11:

The terminal receives work instruction information from the server and presents corresponding tasks to the user.

The input to this step is the set of task lists and display content generated in Step 10. The terminal parses the received instructions, organizes tasks into an interface that shows pending, in-progress, and completed items, and displays details such as item identifiers, shelf locations, and required quantities on the screen.

The terminal allows the user to select a task, mark it as started or completed, and input corrections such as actual picked quantity or notes about missing or damaged objects, and buffers these user inputs for transmission.

The output of this step is a sequence of user interaction events and status updates associated with the assigned tasks.

### Step 12:

The user operates the terminal and the physical environment to execute tasks and generate completion and correction information.

The input to this step is the displayed task information on the terminal and the physical presence of objects at indicated locations.

The user moves through the facility, uses the wireless identification device to rescan identification media at the source and destination locations, picks or moves objects according to the displayed instructions, and confirms completion by selecting corresponding controls on the terminal interface.

The user may enter corrections if the observed conditions differ from the plan, such as reporting that an object is not found at the designated location or that the actual quantity differs from the instructed quantity.

The output of this step is a set of confirmed task completions and correction entries that the terminal prepares for sending to the server.

### Step 13:

The terminal transmits work completion information and correction information to the server for inventory and history updates.

The input to this step is the sequence of user interaction events and status updates produced in Step 11 and Step 12.

The terminal aggregates completion and correction records into structured messages, attaches identifiers for the corresponding tasks and timestamps, and transmits the messages to the server over the established network connection.

The terminal manages retransmission and acknowledgement so that the server reliably receives each status update even under intermittent connectivity.

The output of this step is a set of confirmed completion and correction records delivered to the server.

### Step 14:

The server updates inventory states and historical information based on the completion and correction records, and prepares data for subsequent forecasting cycles.

The input to this step is the set of completion and correction records received in Step 13.

The server applies these records to adjust inventory quantities at source and destination locations, insert new movement history entries, and annotate tasks with final status and exception codes, and reconciles discrepancies between planned and actual movements.

The server then regenerates or schedules regeneration of feature data by incorporating the updated movement history and inventory states, thereby preparing refined input for future prompt sentence construction and forecasting operations.

The output of this step is an updated and internally consistent database state that will serve as the basis for the next execution of the feature generation, prompt construction, and generative AI model invocation steps.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional logistics, inventory management, and customer service systems that rely on wireless identification tags and object tracking primarily focus on numerical and positional data, such as locations, inventories, and transaction histories. These systems typically employ predictive models or rule-based logic that operate only on object-centric data. As a result, although such systems may generate theoretically optimal movement plans or demand forecasts, they often fail to account for human-centric factors such as worker stress, fatigue, or customer confusion. This mismatch can lead to work plans that are difficult or unsafe to execute in practice, reduced overall throughput, and degraded user satisfaction. Moreover, existing systems that introduce machine learning or generative AI models generally treat these models as static components. Input data is preformatted using rigid, hand-crafted templates, and the models are driven by fixed prompts or configuration parameters. Such architectures do not provide a mechanism to systematically feed back execution performance and user state into the generation of prompts or model inputs. Consequently, the generative AI model cannot adapt its behavior over time to changing conditions in the field, such as evolving workload patterns, recurring delay causes, or systematic differences in worker capabilities under different emotion states. This leads to suboptimal scheduling quality, limited robustness, and an inability to continuously improve the effectiveness of AI-supported planning.

From a computer technology standpoint, these limitations manifest as (i) inefficient integration of heterogeneous data sources (object-level telemetry, multimodal user signals, and operational results), (ii) poor utilization of generative AI models due to static prompt sentences and static input parameterization, and (iii) lack of a feedback loop that automatically refines the system's AI interfaces based on objective performance metrics and human-centric context. In such systems, the processor executes fragmented and loosely coupled modules, resulting in increased programming complexity, higher error rates when updating business rules, and degraded scalability when deploying to large, dynamic environments such as logistics centers or retail networks.

Accordingly, there is a need for an improved computer-implemented system in which a processor (1) unifies object tracking data and multimodal emotion estimation into a coherent internal representation, (2) automatically constructs prompt sentences for a generative AI model by summarizing heterogeneous inputs together with explicit preconditions, constraints, and output formats, and (3) continuously refines these prompt sentences and the associated model input parameters using feedback derived from actual execution performance and emotion state transitions. Such an architecture would improve the functioning of the computer system itself by enabling adaptive, data-driven prompt generation, reducing the need for manual rule reconfiguration, and enhancing the quality, safety, and practicality of AI-generated movement and demand predictions and the corresponding instructions delivered to terminal devices.

The specific processing by the specific processing unit 290 of the data processing device 12 in Example 2 is realized by the following means.

The present invention provides a server comprising a processor configured to acquire identification information and position information of physical objects provided with wireless identification tags by means of a position information collection unit, to store, by means of an information storage unit, object position information and movement history information in association with inventory information and sales history information, to estimate, by means of an emotion estimation unit, emotion states of users based on multimodal input including image information, voice information, and operation history information, to generate, by means of a generative AI processing unit, prompt sentences that include summaries of such heterogeneous input information, preconditions, constraint conditions, and required output formats, to supply the prompt sentences together with corresponding structured input data to a generative machine learning model in order to obtain prediction information regarding future object movement and demand, to generate, by means of an instruction generation unit, instruction information specifying execution timings and responsible person assignments for logistics- and customer-related operations based on the prediction information and the estimated emotion states, to transmit the instruction information to terminal devices, and to receive, by means of a feedback unit, performance information regarding task starts and completions from the terminal devices, calculate differences between predicted and actual execution, update statistical indices representing system performance, and dynamically improve templates of the prompt sentences and input parameters of the generative machine learning model based on the updated statistical indices and transitions of the emotion states. This enables an adaptive, feedback-driven computer system architecture in which the processor automatically integrates multimodal human state information with object-level telemetry, continuously refines the generative AI interface at the level of prompt sentences and model inputs, and thereby improves the technical performance of computer-implemented logistics, inventory, and customer service operations in terms of safety, workload balancing, prediction accuracy, and robustness to changing real-world conditions.

The term “wireless identification tag” refers to an electronic identifier that communicates identification information by wireless communication, is attached to a physical object, and stores data that uniquely identifies the physical object.

The term “physical object” refers to a tangible item that is subject to position tracking, inventory management, or logistics management, including goods, products, materials, equipment, or similar entities.

The term “position information collection unit” refers to a functional unit that acquires identification information of a wireless identification tag and corresponding position information of a physical object, for example by using a wireless identification tag reading device and a position information acquisition function of a terminal device.

The term “information storage unit” refers to a functional unit that stores, in an associated storage resource, position information and movement history information of physical objects, together with inventory information, sales history information, and related data, so that they can be retrieved and processed by other units.

The term “inventory information” refers to data indicating a quantity, status, or location of physical objects stored in one or more storage locations, such as shelves, warehouses, or vehicles.

The term “sales history information” refers to data indicating historical transaction records for physical objects, including at least one of sale time, sale quantity, sale location, and product identifier.

The term “terminal device” refers to an information processing device equipped with a display device and one or more input devices, capable of communicating with a server, receiving instruction information from the server, and transmitting sensing data and operation data to the server.

The term “emotion estimation unit” refers to a functional unit that estimates an emotion state of a user by applying at least one of a machine learning process and a rule-based process to image information, voice information, and operation history information associated with the user.

The term “emotion state” refers to information indicating a psychological or physiological state of a user, including at least one of stress, fatigue, irritation, satisfaction, dissatisfaction, confusion, excitement, or calmness, and may be represented by a category, a score, or a continuous value.

The term “emotion state history” refers to a time-series record of estimated emotion states for a user, stored so that changes in the user's emotion state over time can be analyzed.

The term “generative AI processing unit” refers to a functional unit that generates a prompt sentence and supplies the prompt sentence and associated input information to a generative machine learning model so as to cause the generative machine learning model to generate prediction information or other output data.

The term “generative machine learning model” refers to a machine learning model that, in response to input information and an instruction expressed by a prompt sentence, generates new data including at least one of future states, text data, numerical data, or structured data, and includes but is not limited to a language model, a time-series prediction model, or a combination thereof.

The term “prompt sentence” refers to a text sequence that is provided as an instruction to a generative machine learning model, and that describes at least one of a summary of input information, preconditions, constraint conditions, roles, and a required output format.

The term “prediction information” refers to data generated by a generative machine learning model indicating at least one of a future movement destination, a movement time, an occurrence time of demand, a demand quantity, or planning information related to physical objects.

The term “instruction generation unit” refers to a functional unit that generates instruction information specifying at least execution timing and assignment of a responsible person for one or more operations relating to physical objects, based on prediction information and estimated emotion states.

The term “instruction information” refers to data specifying at least one of a type of operation, a target physical object, an execution timing, a deadline, a priority, and an assigned person or terminal device, and is transmitted from a server to a terminal device.

The term “feedback unit” refers to a functional unit that receives performance information from terminal devices, calculates a difference between predicted execution and actual execution, updates statistical indices based on the difference, and adjusts prompt sentence templates or model input parameters accordingly.

The term “performance information” refers to data indicating actual execution of tasks, including at least a work start time, a work completion time, a task identifier, a user identifier, and an execution status.

The term “statistical index” refers to a numerical measure computed from performance information and related data, including at least one of average delay, variance of delay, completion rate, or correlation values between emotion states and execution performance.

The term “prompt sentence template” refers to a parameterized or partially fixed form of a prompt sentence, which defines a structure into which summarized input information, constraints, or other variables are inserted to generate a complete prompt sentence for a generative machine learning model.

The term “input parameter to the generative machine learning model” refers to a configuration value or data element that influences behavior of the generative machine learning model, including at least one of weighting factors, threshold values, time horizons, or tuning values used in conjunction with a prompt sentence.

The term “movement history information” refers to time-series data describing past positions, movements, or locations of a physical object, derived from position information records over time.

The term “position information record” refers to data that associates identification information of a wireless identification tag with at least one of a time, a position of a terminal device, a position of a physical object, or a reception signal strength.

The term “reception signal strength” refers to a measure of intensity of a wireless signal received from a wireless identification tag by a wireless identification tag reading device.

The term “user” refers to a human being involved in management, transportation, or use of physical objects, including at least one of a worker, an operator, a staff member, or a customer.

The term “operation history information” refers to data describing user interactions with a terminal device, including at least one of tap events, button presses, navigation operations, error acknowledgments, and corresponding timestamps, aggregated or recorded over time.

The term “execution timing” refers to a time or time interval at which a specified operation on a physical object is recommended or required to be performed according to instruction information.

The term “responsible person assignment” refers to an association of a task or operation with a particular user or group of users designated to perform the task.

The term “logistics-related operation” refers to an operation involving one or more physical objects in a distribution or storage process, including at least lending, returning, shipping, storing, loading, unloading, picking, or transshipment.

The term “customer-related operation” refers to an operation relating to assistance, guidance, or service provided to a customer, including at least responding to inquiries, providing directions, or adjusting product placement.

The term “safety and workload leveling” refers to constraints and objectives that aim to prevent excessive physical or mental burden on specific users, reduce risk of accidents, and distribute tasks among multiple users in a balanced manner based on emotion states and performance data.

In one embodiment, a server, a plurality of terminal devices, and one or more users cooperate to implement the claimed system. The following description illustrates exemplary hardware configurations, software components, data structures, algorithms, and generative AI processing flows that may be used to realize the functions recited in the claims.

### A. Hardware and Software Configuration of Server and Terminals

Server operates on a general-purpose computing platform including at least one central processing unit (CPU), a main memory, a nonvolatile storage device, a network interface, and optionally a graphics processing unit (GPU). Server executes a server operating system such as a general-purpose server operating system. Server runs an application framework such as a web application framework, a database management system such as a relational database management system, a numerical computation library such as a matrix and vector computation library, a machine learning library such as a deep learning framework, and a natural language processing library capable of running a generative AI model. Terminal operates on a mobile computing platform such as a smartphone, tablet, handheld terminal, or vehicle-mounted terminal. Terminal executes a mobile operating system and runs a client application. Terminal includes a wireless communication interface (for example, a cellular modem, Wi-Fi interface, or Bluetooth interface), a display device such as an LCD or OLED panel, an operation input device such as a touch panel or hardware buttons, a camera as an imaging device, a microphone as a voice acquisition device, and optionally an interface (for example, Bluetooth Low Energy or cable) for connecting to a wireless identification tag reading device.

User is a human worker, staff member, or customer who interacts with terminal. User views instructions shown on the display device of terminal and operates the input device to report work status or interact with displayed information.

### B. Acquisition and Storage of Object Position Information

Terminal connects to a wireless identification tag reading device that reads wireless identification tags attached to physical objects. The tag reading device and terminal communicate via a short-range wireless protocol such as Bluetooth Low Energy. Terminal receives, for each detected wireless identification tag, tag identification information and reception signal strength indication values through a device driver and a communication library of the mobile operating system.

Terminal obtains its own position using a position information acquisition function. Terminal may use a GPS module, a Wi-Fi positioning method, or an indoor positioning method using beacons. Terminal normalizes the position information into a predetermined coordinate system, such as latitude/longitude for outdoor use or grid coordinates for a warehouse map. Server receives position information records from terminal through an application programming interface implemented by the web application framework. Server uses the relational database management system to store each record in an object position history table, in which columns include tag ID, timestamp, X coordinate, Y coordinate, zone identifier, reception signal strength, and terminal ID. Server also maintains an object current position table by updating the latest record for each tag ID.

Server thereby constructs movement history information by joining and time-ordering the position information records. Server uses an index on tag ID and timestamp to accelerate queries for movement history. This structured storage improves data retrieval performance and allows server to efficiently provide movement history information as input to a generative AI model.

### C. Acquisition and Processing of Multimodal User Data

Terminal uses its camera to acquire images including the face or upper body of user. Terminal uses an image processing library such as a general-purpose image processing library or a mobile machine vision API to detect a facial region. Terminal crops the facial region, resizes it to a fixed resolution such as 224×224 pixels, and normalizes pixel values (for example, scaling to the [0, 1] range and adjusting mean and variance). Terminal encodes the preprocessed image in a compressed format such as JPEG and associates metadata such as user ID, terminal ID, and timestamp.

Terminal uses its microphone to capture voice of user. Terminal acquires audio data at a given sampling rate (for example, 16 kHz, 16-bit, monaural) via the audio input interface of the mobile operating system. Terminal segments the audio into clips of predetermined length, optionally removes long silent intervals using a simple voice activity detection procedure, and saves the clips in a standard audio file format such as WAV or a compressed format. Terminal monitors user operations performed via the touch panel and buttons. Terminal logs events such as tap, long press, back navigation, error acknowledgment, and screen transitions with timestamps. Terminal aggregates events in time windows and calculates statistics such as tap count, average tap interval, number of error dialogs, and number of back operations.

Terminal thereby generates operation history information in the form of statistical feature records.

Terminal transmits image files, audio clips, and operation statistics to server via secure HTTP requests. Terminal may batch multiple records and compress payloads to reduce communication load. This batching operation and compression improve overall communication efficiency and reduce network congestion.

### D. Emotion Estimation by Machine Learning Models

Server stores received images and their metadata into an image log table and a file storage. Server uses a machine learning library such as a deep learning framework to load a pretrained facial expression recognition model. In one embodiment, server uses a convolutional neural network (CNN) architecture with multiple convolutional layers, pooling layers, and fully connected layers. Server performs forward inference on the preprocessed facial images to obtain a probability distribution across emotion categories such as joy, anger, sadness, and neutral.

Server calculates, for each face, a face-derived emotion score by treating the output probabilities of the CNN as numerical indicators. Server inserts a record into an emotion-from-face table, associating user ID, timestamp, and the emotion score vector. Server can execute the CNN on a GPU to improve inference speed and to handle many concurrent terminals.

Server processes audio clips using an audio processing library. Server extracts acoustic features such as mel-frequency cepstral coefficients, spectral centroid, energy, and zero-crossing rate for each audio frame. Server arranges these feature vectors as a time sequence and inputs them into a recurrent neural network such as an LSTM model or a transformer encoder trained for speech emotion recognition. Server performs a forward pass to obtain probabilities for emotion labels such as calm, irritation, fatigue, and excited. Server records a voice-derived emotion score in an emotion-from-voice table.

Server processes the operation history information using a conventional machine learning classifier. Server constructs a feature vector from each time-window record and feeds it into a decision tree, random forest, or gradient boosting model trained to classify stress level into low, medium, or high categories. Server stores operation-log-derived emotion scores in an emotion-from-operations table. These models may be trained offline using labeled datasets collected from experimental environments in which user emotion was measured through questionnaires or physiological sensors.

Server combines face-derived, voice-derived, and operation-log-derived emotion scores using a fusion method. Server may implement a linear fusion model with weighting coefficients or employ a small neural network trained on all three inputs. Server calculates continuous emotion indicators such as stress level, fatigue level, and confusion level for each user. Server stores these integrated emotion states in a unified emotion state table.

By integrating multiple modalities, server reduces the variance of emotion estimation and mitigates errors caused by noisy data from any single modality. This multimodal fusion improves the accuracy and robustness of emotion estimation compared to single-source estimation.

### E. Construction of Prompt Sentences for a Generative AI Model

Server periodically or on demand collects various data for a targeted planning horizon, such as the next eight hours. Server queries the relational database to retrieve relevant movement history information, inventory information, sales history information, and unified emotion states. Server uses a numerical computation library to compute aggregated statistics such as average movement frequency between locations, peak shipment times, current inventory utilization percentages, and latest stress and fatigue scores per worker.

Server uses an application logic layer to translate these numerical statistics into human-readable text fragments. For example, server generates phrases such as “Object X: moved between shelf S1 and truck T1 an average of 2 times per day over the last 30 days” or “Worker A: stress 0.8, fatigue 0.7.”

Server uses a prompt sentence template stored in a prompt template table. The template includes placeholders for contextual sections such as object movement history, current inventory status, worker emotion scores, constraints, and required output format. Server fills the placeholders with the generated text fragments and constraints derived from current operating policies, such as thresholds for stress or fatigue beyond which heavy tasks should not be assigned.

Server thereby generates a prompt sentence in natural language. For example, in a logistics center embodiment, server generates a prompt sentence of the following type:

“You are a logistics center scheduler.

Based on the following data, propose a movement plan for the next 8 hours and task assignments for workers.

[Object movement history summary]
Object X: On average, moved between shelf S1 and truck T1 twice per day over the last 30 days.
Object Y: Shipments have been concentrated every Friday between 14:00 and 18:00.

### [Current Inventory Status]

Shelf S1: 80% of capacity used.
Shelf S2: 30% of capacity used.

### [Worker Emotion Scores]

Worker A: stress 0.8, fatigue 0.7
Worker B: stress 0.3, fatigue 0.4
Worker C: stress 0.2, fatigue 0.3

### Constraints:

Do not assign heavy physical tasks to any worker whose stress or fatigue exceeds 0.7.
Complete loading of object X onto truck T1 by 18:00 today.

### Output Format:

Movement destination and departure time for each object.
Concrete task assignments for each worker (time, task description, object ID).”

In a retail store embodiment, server may generate another type of prompt sentence such as:

“You are an operations planner for a retail store.

Based on the following information, propose demand forecasts for the next week and an improved shelf layout.
Past 90 days of sales data by time of day, day of week, and product.
Heatmaps of customer dwell positions and emotion scores (confusion, dissatisfaction).
Current shelf layout and stock levels.

### Goal:

Reduce customer confusion while maximizing sales.

### Output Format:

Demand forecasts for major products (forecasted sales by day of week and time slot).
Concrete proposals for shelf layout changes and guidance signage improvements in high-confusion areas.”

Server stores the generated prompt sentences in a prompt log table to ensure traceability of each generative AI inference. The explicit template and logging allow server to adapt and refine prompt content over time, improving the consistency and quality of the generative AI model outputs.

### F. Generative AI Model Configuration and Training

Server uses a natural language processing library to load a generative AI model. In one embodiment, server uses a transformer-based language model with an encoder-decoder structure or a decoder-only structure including multiple self-attention layers and feed-forward layers. The model receives tokenized prompt sentences as input and outputs token sequences representing predicted plans, schedules, or forecasts.

Server pretrains or fine-tunes the generative AI model using a training dataset consisting of historical planning cases. Each training sample includes a text input representing summarized data and constraints, and a target text representing desired plans or schedules. Server uses a gradient-based optimization algorithm such as stochastic gradient descent with an adaptive learning rate to minimize a loss function such as cross-entropy between generated tokens and reference tokens.

Server may also use reinforcement learning or supervised fine-tuning based on historical performance data. Server can define a reward signal that penalizes predicted plans that lead to high delays or excessive workload for highly stressed workers. By training the generative AI model with such signals, server adjusts model parameters so that the model outputs plans that better satisfy physical constraints and human-centric constraints. This training process improves the internal algorithm of the generative AI model, leading to reduced prediction errors and more stable schedules.

### G. Use of Generative AI Outputs and Instruction Generation

Server calls the generative AI model by sending the prepared prompt sentence and, optionally, additional structured features such as JSON-encoded numeric data. Server sets model parameters like temperature, maximum token length, and stop sequences to control diversity and format of the generated text.

Server receives the generated text and uses a parsing process to extract structured fields, such as object IDs, movement destinations, departure times, assigned worker IDs, and task descriptions. Server converts these extracted fields into movement prediction records and task assignment suggestions. If the generative AI model directly outputs machine-readable lines, such as “Worker A: 15:00-15:30, retrieve object X from shelf S1,” server can apply a deterministic parser to map text to database fields.

Server then applies additional rule-based logic or a constraint solver to enforce domain-specific constraints not fully captured in the generative AI model. For example, server may use a scheduling algorithm implemented in an optimization library to resolve conflicts where two tasks are assigned to the same worker at overlapping times. Server uses emotion indicators such as high stress or fatigue to restrict assignments of heavy tasks. This combination of generative AI output and deterministic post-processing ensures that the final plan adheres to both human-centric and system-level constraints.

Server generates instruction information for each worker. Instruction information includes at least an instruction ID, target physical object ID, recommended start time, deadline, task description, and responsible person. Server writes instruction information into an instruction table and uses a messaging system such as push notification infrastructure to deliver instructions to terminals.

Terminal receives instruction information and displays it on its display device. Terminal can present tasks in chronological order, highlight urgent tasks, and show warnings when tasks involve heavy lifting or high shelves. This structured presentation, based on machine-generated plans, improves user awareness and reduces cognitive load.

### H. Feedback Loop and Technical Improvement of the Computer System

Terminal records actual work start times and completion times input by user. Terminal periodically sends performance information to server. Server stores performance information in a task log table and joins it with corresponding prediction information and instruction information.

Server calculates discrepancies between planned times and actual times. Server applies statistical analysis using the numerical computation library to calculate average delay times, variance, and correlation with emotion states. Server may calculate, for each worker, typical delay profiles at different times of day or under different stress levels. Server then updates statistical indices that describe system performance.

Server uses these statistical indices to improve both prompt sentence templates and model input parameters. For example, server modifies prompt sentences to explicitly include statements such as:

“Consider that workers with a stress score above 0.8 typically experience an average delay of 15 minutes. Adjust the schedule to account for this tendency and minimize overall delay.” Server also adjusts numeric parameters supplied to the generative AI model, such as typical handling times for specific tasks, buffer times for high-stress workers, and weighting factors for emotion variables. These parameters can be stored in a configuration table and retrieved each time server constructs prompt sentences or model inputs.

By implementing this feedback loop, server continuously adapts its internal data structures, prompt sentence generation rules, and model input configurations. This reduces manual tuning and rule rewriting compared to conventional systems, and leads to a measurable improvement in technical performance, such as lower average delay, improved utilization of workers, and more stable schedules under fluctuating conditions.

### I. Technical Effects and Alternative Embodiments

Server improves computer technology in several concrete ways. Server reduces communication load by aggregating multimodal data and transmitting them in batched, compressed forms. Server improves processing efficiency by using structured relational tables and indexed queries to support AI input preparation. Server increases prediction accuracy and stability by integrating multimodal emotion estimation into the generative AI prompt and by continuously updating prompt sentence templates and input parameters based on measured performance. This dynamic adaptation is not a mere automation of human decision-making; instead, it modifies the internal operation of the generative AI interface and scheduling algorithms to reduce errors and computational overhead.

In another embodiment, server uses a different neural network architecture for generative AI processing, such as a recurrent neural network with attention or a hybrid architecture where a time-series prediction module predicts demand quantities and a language model converts numeric predictions into natural language instructions. In another embodiment, server uses convolutional networks for temporal patterns of movement histories and then conditions the generative AI model on intermediate embeddings generated by these networks.

In yet another embodiment, server employs rule-based preprocessing of emotion states. Server may define explicit rules such as “if stress >0.9 and fatigue >0.8, then mark worker as unavailable for heavy tasks.” These rules can be applied prior to generative AI inference to modify the input context. This non-conventional integration of hard constraints and learned models further improves safety and workload leveling.

Terminal may also provide alternative user interfaces. Terminal may display emotion state indicators to user and allow user to self-report adjustments. Terminal may guide user along optimal navigation paths in a warehouse, based on the same prediction information that drives planning. These user interface variations still rely on the same core architecture: multimodal sensing, generative AI planning driven by prompt sentences, and feedback-based adaptation. Through the combination of structured data collection, multimodal emotion estimation, generative AI with prompt sentence templates, deterministic post-processing, and feedback-driven refinement, server, terminal, and user cooperate to implement a computer system that not only automates certain aspects of logistics and customer service but also improves the internal functioning of the computer system in terms of processing efficiency, scalability, and prediction reliability.

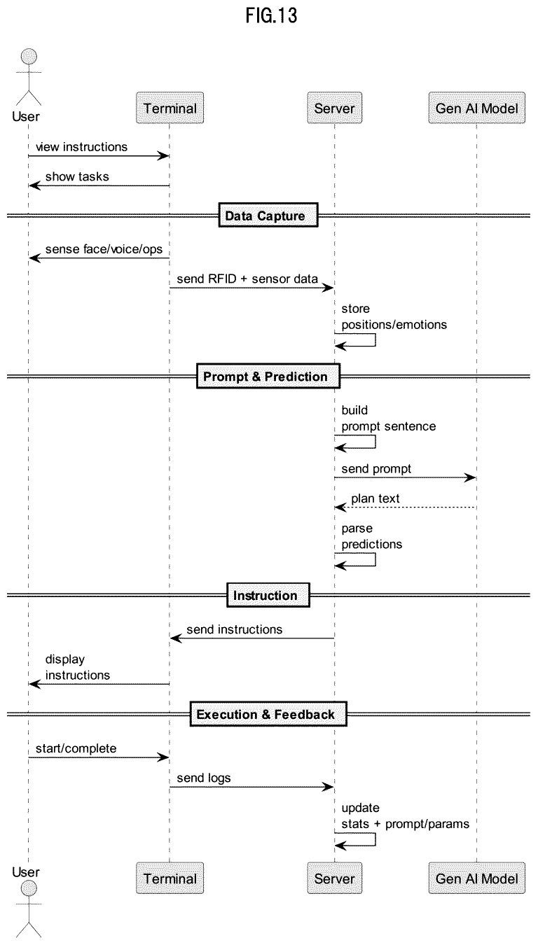

The following describes the processing flow using FIG. 13.

### Step 1:

Terminal acquires wireless identification tag information and terminal position.

Input: raw tag readings from a wireless identification tag reading device; raw position data from a position information acquisition function.

Terminal uses a communication interface (for example, Bluetooth Low Energy) to receive, from the tag reading device, identification information and reception signal strength for each wireless identification tag within range, along with a local timestamp.

Terminal calls a location API of the mobile operating system to obtain current position coordinates (for example, latitude, longitude, and zone identifier).

Terminal performs data processing by combining, for each tag, the tag ID, acquisition time, terminal position, and reception signal strength into a structured position information record.

Output: a collection of position information records, each including tag ID, timestamp, terminal position, and reception signal strength, stored in a local buffer for later transmission to server.

### Step 2:

Terminal acquires and preprocesses user face images for emotion estimation.

Input: raw image frames from the camera device.

Terminal activates the camera and captures image frames that include user's face under predefined triggers (for example, when user opens a work instruction screen).

Terminal uses an image processing library to detect a facial region in each frame, then performs data processing by cropping the region, resizing it to a fixed resolution (for example, 224×224 pixels), and normalizing brightness and contrast values.

Terminal compresses the processed image into a standard format (for example, JPEG), attaches metadata such as user ID, terminal ID, and capture time, and registers the resulting image object in a transmission queue.

Output: preprocessed and compressed face image data objects with associated metadata, ready to be uploaded to server.

### Step 3:

Terminal acquires and preprocesses user audio for emotion estimation.

Input: continuous audio signal from the microphone.

Terminal uses an audio recording API to sample the analog audio at a fixed sampling rate and quantization (for example, 16 kHz, 16-bit PCM) to obtain digital audio samples.

Terminal segments the digital stream into fixed-length clips (for example, 5 seconds), optionally applies simple data processing such as trimming silent intervals based on amplitude thresholds, and encodes the clips into an audio file format (for example, WAV or compressed audio).

Terminal attaches user ID, terminal ID, and time window metadata to each audio clip and inserts these audio objects into an upload queue.

Output: segmented, encoded audio files with metadata, prepared for transmission to server as emotion estimation input.

### Step 4:

Terminal aggregates user operation logs into statistical operation history information.

Input: event streams from the touch panel and other operation input devices.

Terminal records each user interaction event (tap, long press, back navigation, error acknowledgment, screen transition) with an event type and timestamp.

Terminal performs data processing by grouping events into predefined time windows (for example, every 5 minutes) and computing statistics such as number of taps, average tap interval, number of error dialogs, and number of back operations using arithmetic operations.

Terminal creates an operation statistics record per time window, including user ID, window start and end times, and the computed feature values, and stores these records locally.

Output: time-windowed operation statistics records representing user operation history in a compact, feature-based form.

### Step 5:

Terminal transmits collected multimodal data to server.

Input: buffered position information records, preprocessed face image objects, audio files, and operation statistics records.

Terminal packages these data objects into network requests using a serialization format (for example, JSON for metadata, multipart/form-data for binary payloads) and applies optional compression to reduce size.

Terminal uses an HTTP client stack over a secure transport (for example, HTTPS) to send the requests to a server API endpoint and waits for acknowledgments.

Terminal marks successfully transmitted data as sent and may remove or archive local copies according to configuration, thereby freeing local resources.

Output: network data streams containing structured records and media payloads, which server receives and stores as raw input for backend processing.

### Step 6:

Server stores position information and constructs movement history.

Input: collections of position information records received from terminals.

Server validates incoming JSON or structured data (for example, checks tag ID format, timestamp range, coordinate validity) and rejects or logs invalid records.

Server performs data processing by inserting valid records into an object position history table within a relational database, indexing by tag ID and timestamp.

Server updates an object current position table by running an upsert operation to store, for each tag ID, the latest position record.

Output: updated object position history and current position tables, which provide a persistent, queryable movement history of physical objects.

### Step 7:

Server processes face images and estimates face-derived emotion scores.

Input: preprocessed face image files and corresponding metadata.

Server loads a trained convolutional neural network model for facial expression recognition using a machine learning library and initializes it on CPU or GPU hardware.

Server reads each image file into memory, converts it into a normalized tensor, and executes a forward pass through the CNN to compute a probability distribution over emotion categories (for example, joy, anger, sadness, neutral).

Server performs data processing by treating the probability vector as a face-derived emotion score and associates it with user ID and timestamp in an emotion-from-face table.

Output: face-derived emotion score records linked to users and times, stored in a dedicated database table.

### Step 8:

Server processes audio clips and estimates voice-derived emotion scores.

Input: audio files and associated metadata from terminals.

Server uses an audio processing library to load each audio file and compute time-series acoustic features such as mel-frequency cepstral coefficients, energy, and spectral centroids.

Server feeds the feature sequences into a trained time-series neural network (for example, an LSTM or transformer model) and executes a forward pass to obtain probabilities for voice emotion categories such as calm, irritated, tired, and excited.

Server performs data processing by converting the probability distribution into a voice-derived emotion score record and storing it in an emotion-from-voice table indexed by user ID and timestamp.

Output: voice-derived emotion score records reflecting voice-based emotional characteristics of users.

### Step 9:

Server analyzes operation statistics and estimates operation-log-derived emotion scores.

Input: operation statistics records produced by terminals.

Server uses a machine learning classifier, such as a decision tree or gradient boosting model, trained to map feature vectors (tap count, average tap interval, error count, back operations) to stress level categories.

Server constructs feature arrays from each operation statistics record and applies the classifier's prediction function to compute probabilities for stress categories such as low, medium, and high.

Server performs data processing by converting these probabilities into operation-log-derived emotion score records and saving them in an emotion-from-operations table with user identifiers and time windows.

Output: operation-log-derived emotion score records representing stress-related patterns inferred from user interface interactions.

### Step 10:

Server integrates multimodal emotion scores into unified emotion states.

Input: sets of face-derived, voice-derived, and operation-log-derived emotion score records for each user.

Server aligns scores by time, for example by selecting the most recent scores within a configurable time window for each modality.

Server performs data processing by combining modality-specific scores using a fusion function, such as a weighted linear combination or a small neural network, to compute continuous emotion indicators such as stress level, fatigue level, and confusion level.

Server stores the resulting unified emotion state records, including user ID, timestamp, and continuous emotion indicators, in a unified emotion state table.

Output: unified emotion state records representing consolidated, multimodal emotion estimates per user.

### Step 11:

Server summarizes logistics and emotion data to construct a prompt sentence.

Input: movement history information, inventory information, sales history information, and unified emotion state records retrieved from the database for a specified planning horizon.

Server computes aggregated statistics, such as average movement frequency between specific locations, peak shipment times, current inventory usage percentages, and latest stress and fatigue scores for each worker, using database queries and numerical computation.

Server transforms these numerical results into natural language text fragments and inserts them into a stored prompt template that includes placeholders for history summaries, current states, constraints, and required output structure.

Server thereby generates a complete prompt sentence that describes the current context, objectives, constraints, and expected output format for a generative AI model.

Output: a prompt sentence in natural language that encodes heterogeneous system state, constraints, and desired prediction outputs.

### Step 12:

Server invokes the generative AI model with the prompt sentence to obtain prediction information.

Input: the constructed prompt sentence and optionally additional structured numeric or categorical data.

Server tokenizes the prompt sentence according to the vocabulary of a transformer-based generative AI model and passes the tokens to the model running on CPU or GPU.

Server executes an inference process that generates a sequence of output tokens, which are then decoded into a textual response containing proposed movement plans, demand forecasts, and preliminary task assignments.

Server performs data processing by parsing the generative output text, using pattern matching or simple parsing rules, to extract structured prediction information such as object IDs, destinations, movement times, demand quantities, and suggested worker assignments.

Output: structured prediction information consisting of movement prediction records, demand prediction records, and suggested task assignment records.

### Step 13:

Server refines predictions into executable instruction information using emotion states and constraints.

Input: prediction information generated from the generative AI model and unified emotion state records for relevant users.

Server checks each suggested task assignment against emotion-based and domain-specific constraints, such as prohibiting heavy tasks for users with stress or fatigue above defined thresholds.

Server performs data processing by adjusting or reassigning tasks using a rule engine or scheduling algorithm; for example, server may replace a highly stressed worker with a lower-stress worker for a specific heavy lifting task and adjust start times to avoid overlap.

Server assembles finalized instruction information records that specify task details, responsible users, recommended start times, deadlines, and priorities, and stores them in an instruction table.

Output: finalized instruction information records ready to be delivered to terminals as concrete work or customer support instructions.

### Step 14:

Server transmits instruction information to terminals.

Input: instruction information records selected based on their scheduled execution windows. Server formats each instruction record into a message payload that includes textual descriptions, timestamps, identifiers, and any necessary flags (for example, urgency level).

Server uses a messaging or notification service (for example, push notification protocol or persistent socket connection) to send the payload to the terminal device associated with the target user.

Server logs delivery attempts and results, updating delivery status fields in a delivery log table.

Output: instruction messages delivered over the network to corresponding terminals.

### Step 15:

Terminal receives instruction messages and presents them to user.

Input: incoming instruction payloads delivered from server.

Terminal decodes each payload, extracts fields such as task description, start time, deadline, object ID, and priority, and writes these into a local current-task list.

Terminal performs data processing by ordering tasks chronologically or by priority, and generates graphical user interface elements to display task details, alerts, and countdown timers on the display device.

Terminal may render messages such as “At 17:20, retrieve object X from shelf S1 and load it onto truck T1 by 17:30” and optionally plays a sound or vibration to notify user.

Output: visible and audible instructions shown on the terminal screen, enabling user to understand and execute assigned operations.

### Step 16:

User executes tasks and records task progress through the terminal.

Input: task instructions displayed on the terminal.

User physically performs the specified operations, such as moving to a shelf, locating an object, and loading the object onto a transport vehicle.

User interacts with the terminal by pressing a “Start” control when beginning a task and a “Complete” control when finishing, optionally entering comments or selecting problem codes if issues arise.

Terminal captures these interactions as events with timestamps and attaches them to the corresponding instruction IDs and user IDs.

Output: task progress events (start, completion, status updates) stored locally at terminal and ready for transmission to server.

### Step 17:

Terminal transmits task performance information to server.

Input: locally stored task progress events and completion data.

Terminal aggregates these events into performance records that include instruction ID, user ID, actual start time, actual completion time, final status, and any user comments.

Terminal sends these performance records to server via the same secure communication mechanism used for sensing data, ensuring transmission reliability with retry logic if connectivity is intermittent.

Output: structured performance information records received by server for analysis and feedback processing.

### Step 18:

Server analyzes performance information and updates statistical indices and prompt configuration.

Input: performance information records, associated prediction information, and unified emotion state history.

Server joins performance records with corresponding predictions to compute plan-versus-actual metrics such as delays, early starts, and deviations in task durations.

Server performs data processing by aggregating these metrics by user, task type, time of day, and emotion range, and computing statistical indices such as average delay under specific stress levels or variance of completion time per worker.

Server updates a configuration repository that stores prompt sentence templates and numeric model input parameters by inserting new statistical findings, adjusting default buffer times, and encoding empirically derived rules into the prompt text (for example, explicit mention of typical delays under high stress conditions).

Output: updated statistical indices, refined prompt sentence templates, and updated model input parameters that will be used in subsequent iterations of prompt construction and generative AI inference, thereby improving future prediction accuracy and system behavior.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional inventory management and task assignment systems in logistics and other physical environments mainly focus on object states such as stock quantities, locations, and historical movements. These systems typically use database queries, rule-based logic, or traditional prediction models to generate replenishment plans, transport schedules, or task lists. However, such approaches exhibit several technical limitations from the perspective of computer technology.

First, conventional systems do not jointly model multimodal human-related data (for example, images, audio, and biometric signals) with inventory and movement data in a unified computational pipeline. As a result, the processing architecture and data structures are not designed to integrate emotional state estimation with operational planning. The processor simply executes independent modules, leading to fragmented memory access patterns, duplicated data, and non-optimized execution paths. This causes inefficiencies in CPU utilization, increases network traffic between subsystems, and complicates synchronization of state across multiple databases.

Second, existing systems that attempt to use machine learning generally apply specialized models (for example, time-series forecasting models) directly to structured numerical data. They rarely exploit a generative AI model that operates on prompt sentences constructed from heterogeneous operational and human-related data. Consequently, the processor is not configured to perform systematic conversion from relational records to structured natural-language prompt sentences, transmission of such prompt sentences to a generative AI model, and deterministic parsing of the returned free-form text back into structured task and forecast records. Without this architecture, it is difficult to benefit from the adaptability and expressive reasoning capability of generative AI while maintaining deterministic, machine-readable outputs.

Third, even when some form of emotion or workload indicator is considered, conventional systems tend to treat such information as a simple weight or threshold inside a static rule engine. The processor does not dynamically update task assignments in real time based on integrated emotional state indicators derived from multiple sensing modalities. Therefore, conventional systems cannot implement a feedback loop in which multimodal emotion estimation, generative AI-based planning, and programmatic reallocation of tasks are tightly coupled in a single, processor-centric control flow. This results in suboptimal scheduling, increased risk of human error, and inefficient use of system resources, because the task planning kernel is not optimized to react to fine-grained, time-varying emotional state data. Fourth, existing task instruction mechanisms primarily deliver static lists or forms without adapting presentation format to the cognitive load or stress level of the worker. At the computer system level, the processor is not configured to alter the structure and density of instruction messages (for example, single-task view versus multi-task list) as a function of machine-estimated emotional state. This uniform instruction interface can degrade human-computer interaction quality, increase the rate of input errors, and reduce throughput, especially under high-stress conditions. From a technical perspective, a system that programmatically selects instruction formats and message granularity based on numerical emotional indices can reduce UI complexity for stressed users and lower the processing overhead associated with correcting user errors.

Accordingly, there is a need for a computer-implemented system whose processor is specifically configured to: (i) acquire and store position information of tagged objects as well as associated inventory and history information; (ii) estimate worker emotional state as numerical indices from multimodal sensor data; (iii) generate prompt sentences from stored operational data, transmit them to a generative AI model, and parse the model's output to obtain machine-usable demand and movement prediction information; (iv) determine and dynamically modify work plans by reallocating high-load tasks based on predicted demand and emotional state thresholds; and (v) control the format of work instruction output to worker terminals based on the estimated emotional state. Such a system improves the functioning of the computer itself by providing a unified, processor-centric architecture that tightly integrates database operations, multimodal inference pipelines, prompt-based generative AI interaction, and adaptive user interface control.

The specific processing by the specific processing unit 290 of the data processing device 12 in Application Example 2 is realized by the following means.

The present invention provides a server comprising a processor configured to acquire identification information of a wireless identification tag attached to an object by wireless communication and generate position information by associating the identification information with area identification information indicating an area in which the wireless identification tag is present; store, in a storage medium, the generated position information together with inventory information based on the position information and history information related to the object in association with time information; receive, from an information processing terminal held by a worker, at least one of image data, audio data, and biological signal data acquired by an imaging device, an audio acquisition device, or a biological information acquisition device of the information processing terminal, and estimate an emotional state of the worker as at least one numerical index on the basis of the received data; convert, into text data, at least the inventory information and the history information stored in the storage medium, generate a prompt sentence as input for a generative AI model using the text data, transmit the prompt sentence to the generative AI model, receive response text from the generative AI model, and analyze the response text to calculate demand prediction information or movement prediction information related to the object; determine, on the basis of at least the demand prediction information or the movement prediction information, the emotional state, the inventory information, and the position information, contents and execution order of work tasks related to allocation, replenishment, transport, or handling of the object and assignment of workers in charge of the work tasks; dynamically modify a work plan by, among the work tasks thus determined, reducing high-load tasks assigned to a worker whose emotional state exceeds a predetermined threshold and reallocating the high-load tasks among a plurality of workers so that workloads of the plurality of workers are substantially equalized; and output work instruction information to the information processing terminal on the basis of the work plan after the dynamic modification and control presentation contents on the information processing terminal such that, in accordance with the emotional state of the worker, at least one of single-task display and multiple-task list display is selected as a display format. This enables an integrated computer system to efficiently manage memory and processing resources for multimodal emotion estimation, to transform structured operational data into prompt sentences for a generative AI model and deterministically parse model outputs back into structured records, to automatically rebalance work tasks at runtime based on predicted demand and emotional thresholds, and to adapt the user interface output to the worker's emotional state, thereby improving the overall performance, robustness, and usability of the underlying computer-implemented inventory and task management processes.

The term “wireless identification tag” refers to an electronic device attached to an object, the device storing identification information and being configured to transmit or receive the identification information by wireless communication to or from an external reader.

The term “identification information” refers to data that uniquely or semi-uniquely represents an object, such as a code, number, or character string stored in a wireless identification tag and used to distinguish the object from other objects.

The term “area identification information” refers to data indicating a spatial region or location, such as a shelf, zone, or storage area, and used to associate an object with a physical area within a facility.

The term “position information” refers to information that associates identification information of an object with area identification information or coordinate information, thereby indicating a current or past location of the object.

The term “storage medium” refers to any physical medium capable of storing information in a non-transitory manner under control of a processor, including a semiconductor memory, a magnetic storage device, an optical storage device, or a combination thereof.

The term “inventory information” refers to information indicating a quantity, status, or allocation of objects stored or handled in a facility, and is associated with at least an object identifier and a location identifier.

The term “history information” refers to information representing past events related to an object, including at least one of movement events, storage events, transport events, transaction events, and work events associated with the object and time information.

The term “information processing terminal” refers to an electronic device operated or carried by a worker, the device including at least a processor, a display, an input interface, and a communication interface, and being configured to communicate with a server, acquire sensor data, and present work instructions.

The term “imaging device” refers to a device that captures image data, including at least one of a digital camera and an image sensor, and is configured to capture an image of at least a part of a worker or an environment.

The term “audio acquisition device” refers to a device that acquires audio data, including at least a microphone or an equivalent sensor, and is configured to capture sound produced by a worker or an environment.

The term “biological information acquisition device” refers to a device configured to acquire biological signal data from a worker, including at least one of a heart rate sensor, a skin conductance sensor, a temperature sensor, and a respiration sensor.

The term “image data” refers to digital data representing a still image or a sequence of images captured by an imaging device, including at least pixel information and optionally metadata.

The term “audio data” refers to digital data representing sound captured by an audio acquisition device, including at least a time-series waveform or a transformed representation thereof.

The term “biological signal data” refers to digital data representing physiological measurements acquired from a worker, including at least one of heart rate, heart rate variability, skin conductance, body temperature, and respiration rate.

The term “emotional state” refers to a state of a worker's psychological or mental condition, expressed as at least one numerical index such as stress level, fatigue level, or motivation level estimated from sensor data.

The term “numerical index” refers to a scalar or vector value represented by a number or a set of numbers and used to quantify a characteristic such as an emotional state.

The term “generative AI model” refers to a machine learning model configured to generate output data, such as text or structured data, in response to input data, and including at least a language model or a generative model trained on large-scale data.

The term “prompt sentence” refers to text data provided as input to a generative AI model, the text data including at least an instruction, a question, or a description together with context data such as operational records.

The term “response text” refers to text data output from a generative AI model in response to a prompt sentence, the text data including at least a prediction, a plan, or an explanation.

The term “demand prediction information” refers to information representing a forecasted quantity, timing, or pattern of demand for an object, including at least a predicted quantity per time unit and optionally an indication of peak demand periods.

The term “movement prediction information” refers to information representing a forecasted change in location or movement pattern of an object, including at least a predicted time and destination area of a future movement.

The term “work task” refers to a unit of operation performed in relation to an object, including at least one of allocation, replenishment, transport, picking, inspection, and packaging, and defined by attributes such as time, location, and quantity.

The term “work plan” refers to structured information defining a set of work tasks, including at least contents of each task, execution order, execution time, execution location, and assignment of workers in charge.

The term “high-load task” refers to a work task that imposes relatively high physical or mental load on a worker, including at least tasks involving heavy objects, long walking distance, high repetition, or increased risk.

The term “predetermined threshold” refers to a reference value or range defined in advance and used to judge whether a numerical index, such as an emotional state index, is within a normal range or exceeds a limit.

The term “workload equalization” refers to a state in which workloads assigned to a plurality of workers are adjusted to be substantially balanced, based on at least one metric such as estimated work time, number of tasks, or physical effort.

The term “work instruction information” refers to information transmitted to an information processing terminal to notify a worker of a work task, including at least details of the task, such as a location, an object, a quantity, and a timing.

The term “single-task display” refers to a display mode in which work instruction information for only one work task is presented on a screen at a time.

The term “multiple-task list display” refers to a display mode in which work instruction information for a plurality of work tasks is presented as a list or table on a screen at the same time.

The term “worker” refers to a human operator who performs at least one work task related to an object, using an information processing terminal and optionally interacting with a server.

The term “processor” refers to hardware configured to execute instructions, including at least a central processing unit or an equivalent computational unit, and to control acquisition, storage, analysis, and output of data according to a program.

In one embodiment, a server, a terminal, and a user cooperate to implement the system. The server executes an information processing program on a hardware platform including at least one multi-core processor, a main memory, a non-volatile storage device, and a network interface. The server runs a server-class operating system, such as a general-purpose Unix-like system. The server executes database management software, such as a relational database management system, and exposes web application interfaces using a web application framework. The server further uses software libraries for image processing, acoustic feature extraction, and machine learning, such as an image processing library, an audio analysis library, and deep learning frameworks. The server accesses a generative AI model either via an external network-based API or as a locally deployed large-scale language model.

The terminal is implemented as a mobile information processing device, such as a handheld terminal, a smart phone, or a tablet, equipped with a processor, a display, an input interface, a wireless communication interface, an imaging device, and an audio acquisition device. The terminal runs a mobile operating system and executes an application that communicates with the server through secure network protocols. The terminal can further communicate, via a short-range wireless interface, with an external wireless identification tag reader and with a wearable device including biological information acquisition devices.

The user is a worker who operates in a physical facility, such as a warehouse or a logistics center, and carries or wears the terminal and the wireless identification tag reader. The user manipulates physical objects to which wireless identification tags are affixed, and follows work instructions displayed on the terminal.

Server implements position information acquisition by cooperating with a wireless identification tag reader. The wireless identification tag reader reads identification information from wireless identification tags via radio frequency communication and transmits the identification information, together with reader position information or area identification information, to the terminal. Terminal receives the identification information and area identification information and transmits them to the server using a structured message format. Server stores the received information in the storage medium as records in a position information table, where each record includes at least: a tag identifier, an object identifier associated with the tag identifier, an area identifier, a reading timestamp, and optional signal strength values.

Server derives inventory information from position information by executing aggregate queries on the position information table. Server uses the relational database engine to perform grouping by object identifier and area identifier and to compute aggregate quantities by summing or counting tag instances. Server stores the computed quantities as inventory information in an inventory table. By maintaining both the position information table and the inventory table, server enables fast queries for current stock levels and historical movements, and reduces the number of per-request aggregation computations required at runtime, thereby improving computation efficiency and memory access locality.

Server uses a set of tables to manage history information, including at least an object history table storing events such as storage, movement, allocation, transport, and transaction events. Each event record includes an object identifier, a source and destination area identifier, a timestamp, a quantity, and an event type code. Server relates these records to the position information and inventory information to construct movement trajectories and stock-flow histories.

Terminal acquires multimodal sensor data for emotional state estimation while the user performs physical work. Terminal periodically activates the imaging device to capture images of the user's face. Terminal uses an image processing library on the device to detect a face region by applying a face detection algorithm, such as a cascade classifier or a convolutional neural network-based detector. Terminal crops the detected face region, resizes it to a predetermined resolution, and normalizes pixel values. Terminal compresses the processed image into a compressed format and transmits the compressed data, together with a user identifier and a timestamp, to the server.

Terminal also records audio data using the audio acquisition device. Terminal records short audio segments and optionally applies an audio analysis library to compute acoustic features, such as spectrograms or mel-frequency cepstral coefficients, by performing a short-time Fourier transform on the waveform. Terminal transmits either the raw waveform or the extracted audio features, together with user identification data, to the server.

Terminal further receives biological signal data from the wearable device via the short-range wireless interface. The wearable device measures at least one of heart rate, heart rate variability, skin conductance, body temperature, and respiration rate. Terminal aggregates measured samples over specified time windows and computes statistical features, such as means, variances, and extrema. Terminal transmits these biological signal features to the server.

Server performs emotion estimation by implementing a multimodal machine learning pipeline. Server stores the image data, audio data, and biological signal data in raw or preprocessed form in corresponding tables of the storage medium. Server pre-processes face images by converting compressed image data into numerical tensors with standardized dimensions and normalized pixel values. Server inputs such tensors into a trained neural network for facial expression recognition. This neural network may be implemented as a convolutional neural network with multiple convolutional layers, pooling layers, fully connected layers, and a softmax output layer that yields a probability distribution over basic emotion categories. Server stores the resulting probabilities as numeric fields associated with a user identifier and timestamp.

Server processes audio data by computing or receiving audio features (for example spectrograms) and inputting them into a separate emotion recognition neural network. This neural network may be implemented as a recurrent neural network or a convolutional network operating on time-frequency feature maps. The network outputs continuous scores indicating degrees of anger, tension, or fatigue. Server normalizes these scores to a standard scale (for example 0 to 1) using stored normalization parameters and saves them as time-series entries. Server processes biological signal data by combining statistical features, such as average heart rate, heart rate variability indices, and skin conductance metrics, with terminal operation logs (for example mean input rate and error rate) to form feature vectors. Server applies a machine learning model, such as a gradient boosting machine or a fully connected neural network, to these feature vectors. The model outputs a baseline stress score and a physiological fatigue score. Server stores these scores as separate numeric indices.

Server integrates these modality-specific outputs into an overall emotional state index using a multi-layer perceptron model. The multi-layer perceptron receives as input a concatenated feature vector composed of facial expression probabilities, audio emotion scores, biological signal scores, and operation log features. The multi-layer perceptron includes at least one hidden layer with a specified number of units, nonlinear activation functions, such as rectified linear units, and an output layer producing one or more emotional state indices, such as combined stress level, combined fatigue level, and motivation level. Server periodically executes this integration model for each user and records the integrated indices in an emotion data table. Server also aggregates these entries over longer time windows using statistical database functions, storing aggregated values in an emotion summary table. This architecture reduces the need for repeated cross-modal joins at query time and enables fast retrieval of up-to-date emotional indicators.

Server trains the emotion-related neural networks in advance using historical labeled data. During training, server defines a loss function, such as cross-entropy loss for classification or mean squared error for regression, and updates model weights using gradient-based optimization methods, such as stochastic gradient descent or adaptive moment estimation. Server may perform data augmentation, such as random cropping and flipping for images, background noise addition for audio, and window shifting for time-series biological signals, to improve model robustness. Trained parameters are stored and loaded at inference time, so the runtime processing focuses on deterministic feed-forward computations with bounded computational cost.

Server uses the stored inventory information and history information to construct prompt sentences for a generative AI model. Server selects records from sales or movement history tables and formats them as textual lines, each containing a date and a quantity or other numerical attribute. Server concatenates these lines with explanatory text to form a prompt sentence. For example, server generates a prompt sentence in the following style: “You are a demand forecasting assistant.

Below is the past 6 months of daily sales data for one product. Each line is ‘date, sales_quantity’.

Based on this data, predict the demand (expected sales quantity) for each day of the next month. Also, list the days on which you expect particularly high demand and briefly explain the reasons (such as day-of-week pattern, seasonality, or holidays).

### Data:

2023 Jul. 1, 35
2023 Jul. 2, 40
. . .
2023 Dec. 31, 50”

Server transmits this prompt sentence to the generative AI model. When the generative AI model is accessed via an external API, server sends the prompt sentence within a request message over a network connection. When the generative AI model is locally deployed, server passes the prompt sentence to a language model implementation. The generative AI model generates a response text which contains predicted quantities for future dates and explanations of expected demand peaks. Server uses deterministic parsing rules and regular expressions to extract date-quantity pairs and labels of peak days from the response text and writes the extracted values into a demand prediction table.

Server also constructs prompt sentences for work plan generation that integrate inventory information, demand prediction information, and emotional state summaries. Server selects inventory records for multiple objects, demand predictions summarizing expected quantities and peak days, and emotional state indices from the emotion summary table. Server formats these data into a textual header and tabular descriptions. For example, server generates a prompt sentence in the following style:

“You are the optimization engine of a warehouse management system.

Below are (1) the current inventory data, (2) the demand forecast for the next week, and (3) the emotional state data for each worker (stress and fatigue scores between 0 and 1). Your goal is to create a picking and replenishment schedule for the next week that satisfies the following conditions:
(1) Avoid stockouts and excessive overstock by appropriately timing replenishment.
(2) For workers with high stress or fatigue scores, reduce tasks that involve high risk (for example working at height) or long walking distances.
(3) Distribute the total workload as evenly as possible among all workers.

### Inventory Data:

Product A: Shelf X, quantity 100
Product B: Shelf Y, quantity 50

### Demand Forecast Data:

Product A: total 200 units next week (especially high demand on Wednesday and Friday)
Product B: total 80 units next week
. . .

### Worker Emotion Data:

Worker1: stress_score=0.8, fatigue_score=0.7
Worker2: stress_score=0.3, fatigue_score=0.2
Worker3: stress_score=0.5, fatigue_score=0.4

Based on these data, propose a concrete 1-week work assignment plan specifying for each worker which shelves to pick from, which products to pick, how many units per task, and at what times to perform replenishment tasks.”

Server transmits this prompt sentence to the generative AI model and receives a response text that describes a proposed work plan in natural language or semi-structured format. Server applies rule-based parsers that recognize patterns, such as “Worker1, Monday morning, Shelf X, 20 units of Product A”, and converts these patterns into structured task records. Each record includes a worker identifier, a time slot, a position identifier, an object identifier, a quantity, and a task type. Server stores these records in a work plan table.

Server further processes the initial work plan based on emotional threshold rules. Server compares the emotional state indices for each worker, stored in the emotion summary table, against predefined thresholds. When a worker's stress or fatigue index exceeds a threshold, server identifies high-load tasks assigned to that worker. Server characterizes a task as high-load based on rules involving object weight, walking distance estimated from position identifiers, expected duration derived from historical average task durations, and risk flags such as high-shelf picking. Server then selects alternative workers with lower emotional indices and available time slots, and programmatically reassigns high-load tasks to such workers while recomputing per-worker workload metrics. This dynamic reassignment algorithm achieves workload equalization and ensures that the work plan respects emotional constraints, thereby reducing error risk while maintaining throughput. Because the algorithm operates on structured task records and precomputed emotional indices, server can perform reassignment using efficient database updates and in-memory computations, which leads to reduced CPU load and shorter response times compared to manual or ad hoc approaches. Server generates work instruction information for each worker by selecting tasks from the confirmed work plan and forming output messages. When the current emotional state of a worker is above a threshold, server constructs a message that contains only one task at a time, with simplified language and clear highlights for location and quantity. When the emotional state is within a normal range, server constructs a message containing multiple upcoming tasks in a list format. Server transmits the work instruction information to the terminal using structured messages. This adaptive presentation logic reduces the likelihood of user interface errors for stressed users and also reduces the number of corrections and retries, which in turn reduces network traffic and server-side processing associated with error handling.

Terminal receives the work instruction information and displays it on the screen according to the specified format. When configured for a single-task display, terminal shows one task with large text and clear buttons for starting and completing the task. When configured for multiple-task list display, terminal shows several tasks in a list with scrolling and selection controls. The user reads the instructions, moves to the specified area, and manipulates the physical objects according to the instructions. Upon completion, the user presses a completion button, and terminal transmits a completion notification to the server. Server updates the corresponding task record in the work plan table and logs completion in a work log table, which can be used for further analysis and system optimization.

In an alternative embodiment, server uses different model architectures. For example, the facial expression model can be replaced by a vision transformer-based network, and the audio emotion model can be implemented using a temporal convolutional network. The generative AI model may be a transformer-based large language model deployed on-premises, in which case server invokes a local inference engine instead of an external API. The structure of the prompt sentences can be modified to include additional constraints or data fields, such as specific service-level targets or maximum walking distance per shift. The emotion integration model can be configured to output a larger set of indices, including, for example, focus level or anxiety level, which can be incorporated into task assignment rules.

In another embodiment, server reduces communication load by caching recent emotional indices and by transmitting only incremental updates of inventory and history data to the generative AI model. For example, server constructs prompt sentences that include only recent changes instead of full histories when an incremental forecast or adjustment is sufficient. This reduces the volume of data transmitted to the model and shortens the time required to generate a new plan. Server may also employ compression for the text payloads used as prompt sentences.

Because server organizes data into dedicated tables for position, inventory, history, emotion, demand prediction, and work plans, and because server uses optimized queries and precomputed aggregates, the system reduces database contention and improves throughput for concurrent requests. The use of prompt sentences to interface with a generative AI model allows the system to incorporate complex reasoning and flexible planning without requiring extensive custom algorithm development for each operational scenario. At the same time, deterministic parsing of model output into structured records ensures that downstream processes, such as task assignment and load balancing, remain machine-executable and verifiable.

By integrating multimodal emotion estimation, generative AI-assisted planning, and rule-based dynamic task reassignment within a single server-centric architecture, the system improves core computer operations, including model inference workflows, database access patterns, and user interface generation. These improvements yield increased prediction accuracy for demand and workload, reduced computation time for plan generation and adjustment, better memory utilization through pre-aggregation and feature caching, and lower communication overhead by using compact prompt sentences and adaptive instruction formats. The system therefore provides technical effects beyond mere automation of human planning, resulting in a concrete improvement in computer technology applied to physical object management and worker task guidance.

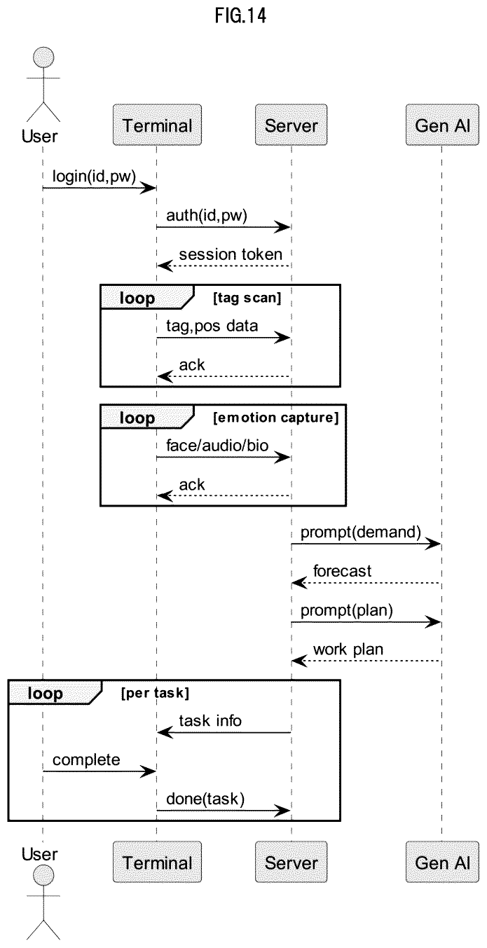

The following describes the processing flow using FIG. 14.

### Step 1:

Server initializes data structures and models.

Server loads configuration files from storage as input, including database connection parameters, wireless identification tag mappings, model file paths, and generative AI endpoint settings. Server, based on this input, opens connections to the relational database and creates in-memory caches for frequently used lookup tables such as tag-to-object mappings. Server loads trained neural network parameters for facial expression recognition, audio emotion recognition, biological-signal-based stress estimation, and multimodal emotion integration into memory from stored model files. Server also configures the client library for accessing the generative AI model API, setting authentication tokens and timeout parameters. Server outputs a ready state in which database sessions, model objects, and network clients are initialized and reusable by subsequent processing.

### Step 2:

Terminal authenticates the user and establishes a session.

Terminal displays a login screen and receives, as input from the user, a user identifier and authentication data through the touch interface. Terminal sends a login request containing these values to the server. Server receives the request as input and queries the user table in the database to retrieve the stored password hash and account status. Server computes a hash of the received password using a cryptographic hash function and compares it with the stored hash. If the comparison succeeds, server generates a random session identifier and an authentication token using a random number generator and stores them in a session table along with the user identifier and login timestamp. Server sends the session identifier and token to the terminal as output. Terminal stores these values in a secure local storage and attaches the token as an authorization header in subsequent API requests. This processing converts plain authentication data into a secure session context that is reused as input for all later communication.

### Step 3:

Terminal acquires wireless identification tag readings and sends position-related data. Terminal receives wireless identification tag identification codes and signal strength values from a wireless identification tag reader via a short-range wireless interface as input. Terminal also queries a local positioning module, which uses wireless access point signals or beacons, to obtain an estimated area identifier where the terminal and reader are located. Terminal combines the tag identifiers, timestamps, signal strength values, and area identifier into position records in memory. Terminal, after collecting multiple records in a buffer, serializes them as a structured message and sends the message to the server as output. Server receives the structured message as input, parses each position record, and stores each record into a position information table in the database. Server further uses a tag-to-object mapping table to convert each tag identifier into an object identifier and calculates inventory deltas per area and object. Server updates the inventory table by adding or adjusting quantities and outputs updated inventory information that will be referenced in later steps.

### Step 4:

Terminal captures facial images and transmits processed image data.

Terminal periodically activates the imaging device and captures an image frame of the user's face as input. Terminal applies a face detection algorithm from an image processing library to the frame to detect a face region and obtains bounding box coordinates. Terminal crops the image to the face region, resizes it to a fixed resolution, and normalizes pixel values (for example by scaling to a fixed numeric range). Terminal compresses the processed face image into a compressed format and packages it together with a user identifier and a timestamp into a transmission payload. Terminal sends this payload to the server as output. Server receives the payload as input, decodes the compressed image, and converts it into a numerical tensor with the expected input shape of the facial expression recognition neural network. Server feeds the tensor into the network, executes a forward pass, and obtains class probabilities for multiple emotion-related categories. Server stores these probabilities as numeric fields in an emotion data table and outputs an intermediate facial emotion representation for further integration.

### Step 5:

Terminal records audio segments and transmits acoustic features.

Terminal monitors the audio acquisition device and records short audio segments at fixed intervals as input. Terminal converts the raw waveform into a numeric array and applies an audio analysis library to compute acoustic features such as time-frequency spectrograms or mel-frequency cepstral coefficients. Terminal performs a short-time Fourier transform over overlapping windows, calculating magnitude values per time-frequency bin as a data computation. Terminal constructs a feature matrix representing the segment and attaches the user identifier and timestamp. Terminal sends this audio feature payload to the server as output. Server receives the audio features as input and standardizes them (for example by subtracting a mean and dividing by a standard deviation computed during training) to form a normalized feature tensor. Server forwards the tensor through an audio emotion recognition neural network and calculates numeric scores for vocal anger, tension, and fatigue. Server writes these scores into the emotion data table and outputs an audio-based emotion representation.

### Step 6:

Terminal collects biological signals and sends statistical features.

Terminal receives biological signal measurements such as heart rate, heart rate variability, and skin conductance from a wearable device via a short-range wireless interface as input. Terminal collects samples over a defined time window and performs statistical computations, including calculation of mean values, variances, and maximum and minimum values, for each signal type. Terminal aggregates these statistics into a feature vector and associates the vector with a user identifier and a time window identifier. Terminal sends this feature vector to the server as output. Server receives the biological feature data as input and may combine it with locally stored terminal operation metrics such as keypress frequency or error count retrieved from logs. Server constructs a composite feature vector and feeds it into a trained stress estimation model, such as a gradient boosting machine or a small neural network, and computes a stress index and a physiological fatigue index. Server stores these indices in the emotion data table and outputs a biological-signal-based emotion representation.

### Step 7:

Server integrates multimodal emotion data into unified emotional state indices.

Server periodically retrieves, as input, recent facial emotion probabilities, audio emotion scores, and biological-signal-based indices for each user from the emotion data table. Server normalizes and concatenates these modality-specific feature vectors into a single multimodal feature vector for each user and time window. Server feeds this multimodal vector into a multi-layer perceptron model configured with at least one hidden layer and a non-linear activation function. Server executes the model inference to output unified emotional state indices, including at least a combined stress level, a combined fatigue level, and a motivation level. Server writes these indices into the emotion data table as detailed time-series entries and also computes aggregated indices over longer periods using database aggregation functions, storing the aggregated values in an emotion summary table. The output of this step is a set of normalized emotional state indices per user and time period, which serve as input constraints for planning and instruction-generation logic.

### Step 8:

Server prepares historical operational data and generates a demand forecasting prompt sentence.

Server receives a demand forecasting request that includes an object identifier and a prediction horizon as input. Server queries the history information table and inventory table to fetch past daily quantities, such as sales counts or movement counts, associated with the given object. Server sorts these records by date and formats them into lines of text in the form of “date, quantity.” Server also gathers current inventory quantities and key storage areas for the object and converts them into explanatory sentences. Server concatenates the explanatory text and the series of “date, quantity” lines to create a demand forecasting prompt sentence addressed to the generative AI model. Server sends this prompt sentence to the generative AI model through an API call as output. Server then receives response text from the generative AI model as input, which includes predicted quantities for future dates and descriptions of peak periods. Server parses the text using pattern-matching rules to extract forecasted quantities and peak-day labels and writes these values into a demand prediction table. The output is structured demand prediction information that will be consumed by subsequent planning processes.

### Step 9:

Server prepares integrated data and generates a work plan prompt sentence.

Server, upon initiating work plan generation, retrieves as input demand prediction information for multiple objects, current inventory and position information, and emotional state summaries for each worker from the relevant tables. Server formats inventory data into human-readable lines such as “Product A: Shelf X, quantity 100” and summarizes demand predictions into lines such as “Product A: total 200 units next week (especially high demand on Wednesday and Friday).” Server converts emotional state summaries into text of the form “Worker1: stress_score=0.8, fatigue_score=0.7.” Server constructs a work plan prompt sentence that explains planning goals and constraints, then embeds the formatted inventory data, demand prediction data, and emotional state data. Server sends this prompt sentence to the generative AI model as output. Server receives a response text that describes a proposed weekly schedule including tasks mapped to workers, shelves, times, and quantities as input. Server parses the text to extract atomic tasks, identifies worker identifiers, time slots, location identifiers, object identifiers, and quantities, and records each task as a row in a work plan table. The result is an initial set of structured work tasks generated by combining operational data and generative AI output.

### Step 10:

Server adjusts work tasks based on emotional thresholds and workload equalization. Server rereads, as input, the initial work plan and the latest emotional state indices for each worker from the work plan table and the emotion summary table. Server identifies workers whose stress index or fatigue index exceeds a predetermined threshold and then selects tasks categorized as high-load based on object weight, distance calculations derived from position identifiers, and risk attributes associated with the task type. Server searches for alternative workers with lower emotional indices and overlapping availability in the same time frame and area. For each candidate reassignment, server recomputes estimated workload metrics, such as total assigned duration and total walking distance per worker, by summing task times and estimating distances between successive task locations. Server reassigns high-load tasks to alternative workers when such reassignment improves workload balance without violating timing or location constraints. Server updates the corresponding records in the work plan table and outputs a revised, emotion-aware work plan that is ready for instruction generation.

### Step 11:

Server generates adaptive work instruction information and sends it to the terminal. Server selects, as input, the next set of tasks scheduled for each worker from the revised work plan table and fetches the worker's current emotional state indices from the emotion summary table. Server evaluates whether each worker's emotional state exceeds a threshold. For workers with high stress or fatigue, server constructs work instruction messages containing only a single task description at a time, formatted with simplified language and highlighted key parameters, such as location, object, and quantity. For workers with normal emotional indices, server constructs instruction messages listing multiple upcoming tasks in an ordered list with detailed timing information. Server packages each message with a worker identifier and sends it to the corresponding terminal as output. Terminal receives the message as input, parses the contents, and renders the instructions on the display using the specified format. The output of this step is a visual work instruction interface tailored to each worker's emotional state.

### Step 12:

User executes physical tasks and reports completion via the terminal.

User observes the instructions on the terminal display as input to human action, moves through the facility to the specified area, and physically manipulates the objects as directed by the work instruction information. User, upon completing a task, interacts with the terminal by pressing a completion button or performing a specified input gesture. Terminal receives this user input and constructs a completion message including a task identifier, completion timestamp, and optional comments. Terminal sends the completion message to the server as output. Server receives the completion message as input, updates the corresponding entry in the work plan table to mark the task as completed, and logs the event in a work log table. Server may then select the next task for that user according to the work plan and emotional state constraints and returns to the instruction-generation flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

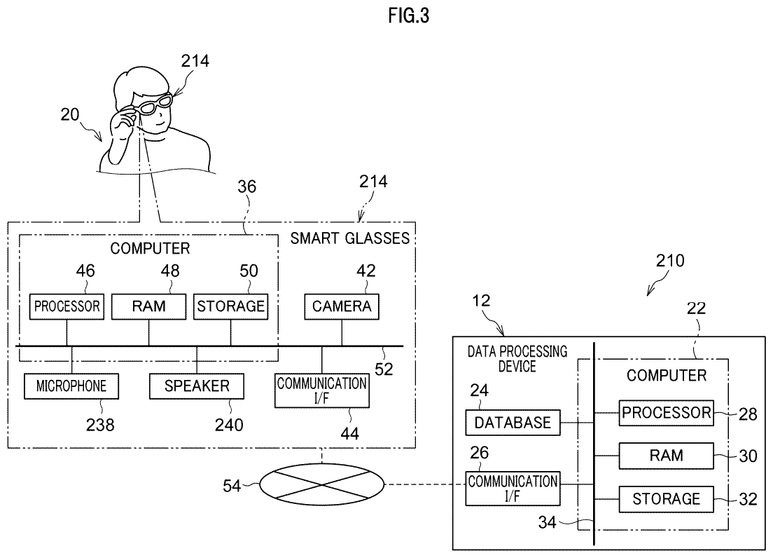

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

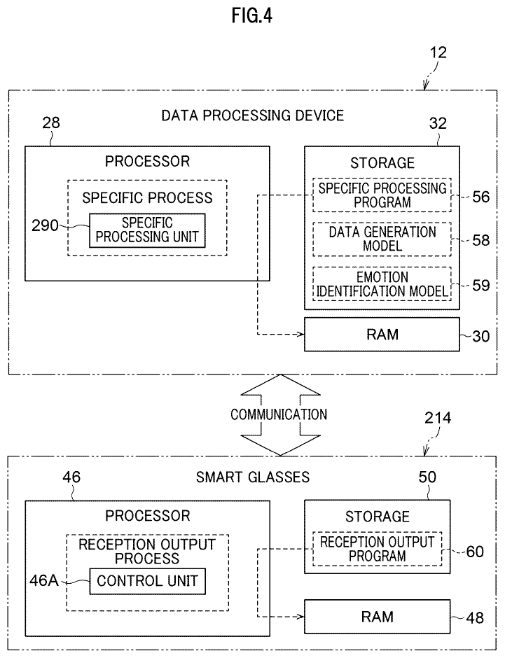

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

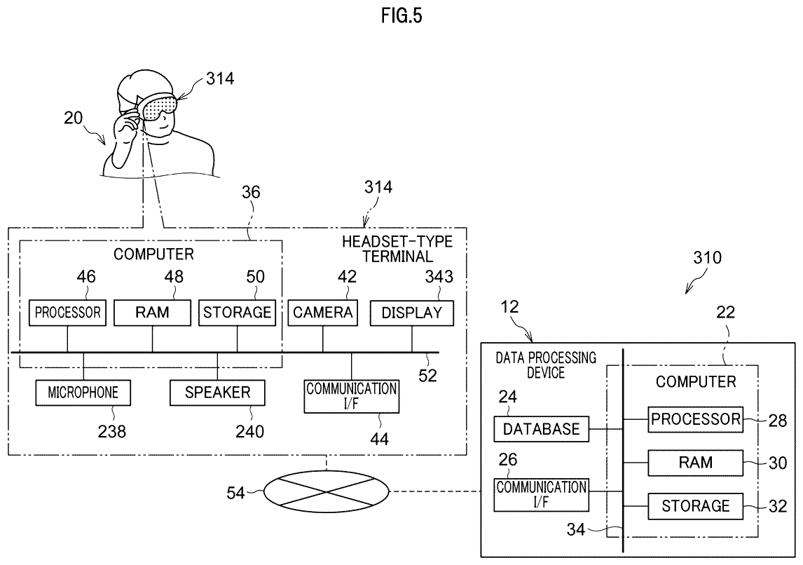

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

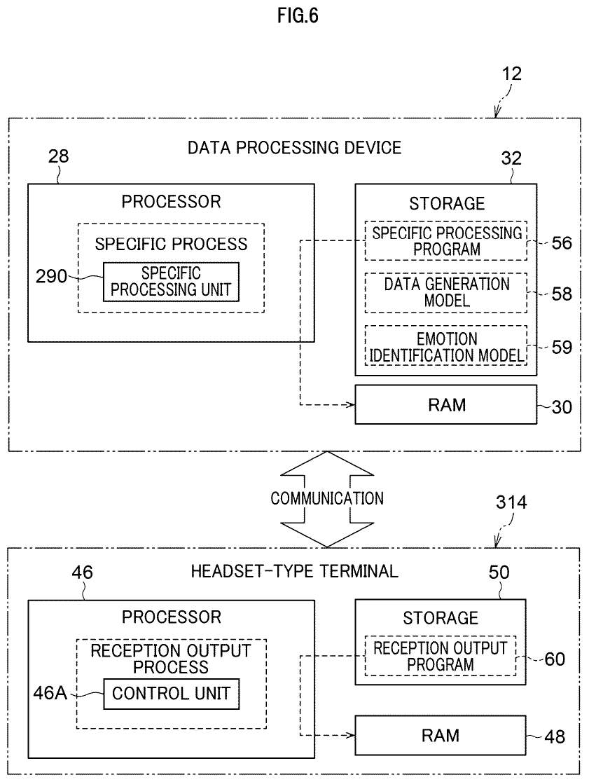

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

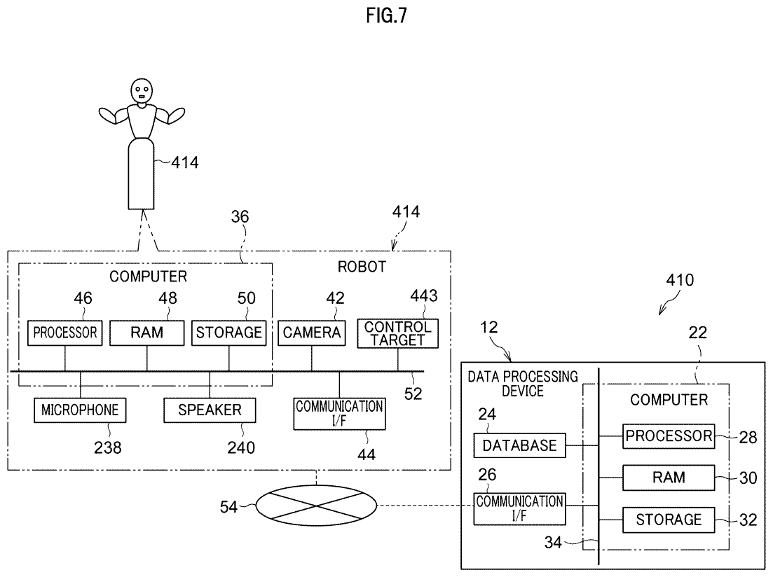

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

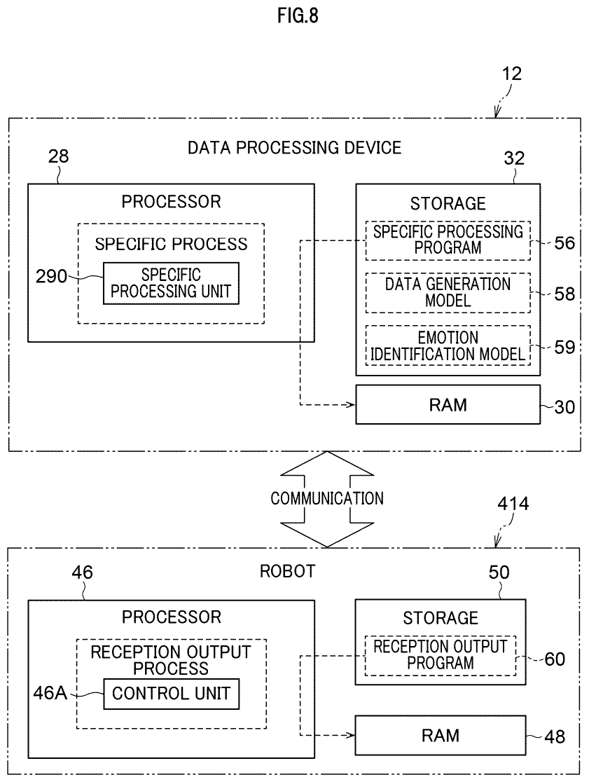

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user.

Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

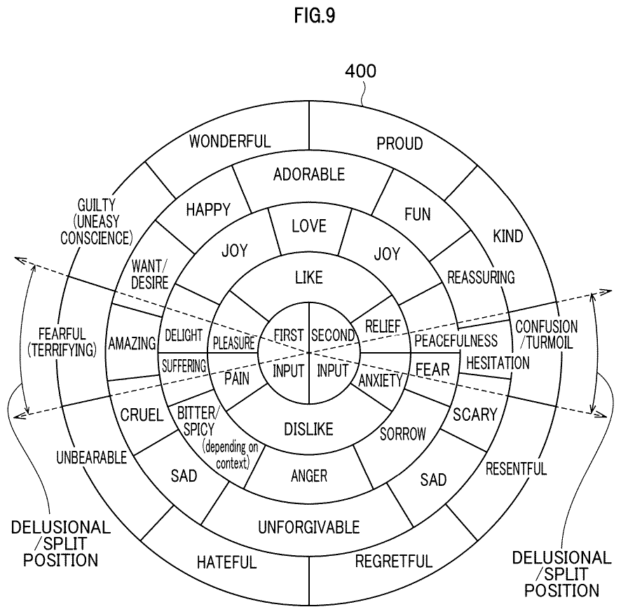

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

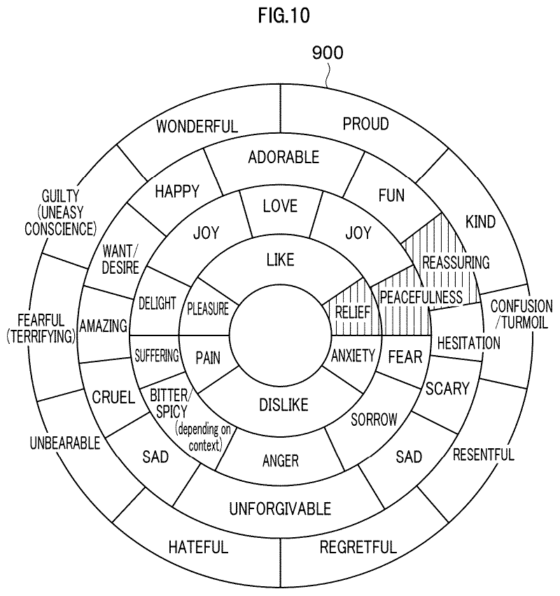

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire position information of an object provided with identification information by using an information reading device connected to an information processing apparatus, and generate position information data by associating the acquired position information with time information at acquisition and installation position information of the information reading device,
transmit the generated position information data via a communication network to the information processing apparatus, and, in the information processing apparatus, store the position information data as history information while normalizing and managing the position information data as current position information and movement history information of each object,
extract, on the basis of the stored movement history information and the current position information, history information to be analyzed in accordance with a predetermined extraction condition, and generate structured data representing an extraction result,
generate, on the basis of the structured data and operation condition information, a prompt sentence in a natural language, input the prompt sentence as an input to a generative information processing model, and cause the generative information processing model to generate prediction information relating to a future destination, a future movement time, or a future demand quantity of the object,
calculate, on the basis of the prediction information, task instruction information including at least one of a start time, an execution order, and an assigned apparatus for a transfer operation, a storage operation, or an inventory replenishment operation, and distribute the task instruction information to an information terminal including a display device or an alarm device, and
cause the information terminal, on the basis of the distributed task instruction information, to notify a worker, generate work result information on the basis of operation input from the worker or again acquired position information data, and transmit the work result information to the information processing apparatus so that the work result information is stored again as evaluation data for the movement history information and the prediction information.

### (Supplementary 2)

The system according to supplementary 1,
wherein the processor is configured to
configure the prompt sentence in the natural language to include a description sentence containing at least part of time-series movement history information, inventory information, and sales history information, and an instruction sentence defining a content and an output format of prediction requested from the generative information processing model, and automatically improve contents of the prompt sentence in accordance with prediction accuracy or work efficiency by variably changing a composition of the description sentence and the instruction sentence.

### (Supplementary 3)

The system according to supplementary 1,
wherein the processor is configured to
calculate a prediction error on the basis of a time difference or a position difference between the prediction information obtained from the generative information processing model and actual work result information and actual movement result information, and sequentially adjust the prompt sentence and usage conditions of the generative information processing model by updating at least one of a period, an item, and a weight of history information included in the prompt sentence in accordance with the prediction error.

### Application Example 1

### (Supplementary 1)

A system comprising a processor,
wherein the processor is configured to acquire information of identification media by using a wireless identification device, to collect position information of objects in real time, and to transmit the collected position information to a storage unit via a predetermined communication method,
wherein the processor is configured to store, in the storage unit, the received position information and historical information including past sales information and shipment information in time series, and to manage an inventory state and a movement history for each object based on the position information and the historical information,
wherein the processor is configured to generate feature data of inventory amounts and demand for each object from the position information and the historical information, and to construct a prompt sentence to be input to a generative AI model by converting the feature data into a natural language format or a table format,
wherein the processor is configured to transmit input data including the prompt sentence to the generative AI model, and to obtain, from the generative AI model, a response including demand forecast information and inventory shortage risk information,
wherein the processor is configured to calculate, based on the demand forecast information and the inventory state, a replenishment amount, a relocation amount, and an ordering time for each object, and to generate work instruction information for a robotic apparatus, an information terminal apparatus, and a supply apparatus,
wherein the processor is configured to transmit the work instruction information to the information terminal apparatus so as to cause the information terminal apparatus to display work contents to a user, to transmit control instructions related to transport and picking of the objects to the robotic apparatus, and to transmit electronic ordering information to the supply apparatus, and
wherein the processor is configured to receive work completion information and correction information input from the information terminal apparatus, to update the inventory state and the historical information based on the work completion information and the correction information, and to reflect an update result in generation of a subsequent prompt sentence and in subsequent demand forecasting processing.

### (Supplementary 2)

The system according to supplementary 1,
wherein the processor is configured to cause the prompt sentence to include statistical information indicating, for each object, a sales amount and a shipment amount in a predetermined past period and a current inventory amount, and a description that requests the generative AI model to output, in a predetermined structured format, a future demand amount for each object, a probability of an inventory shortage, and a safety stock amount.

### (Supplementary 3)

The system according to supplementary 1,
wherein the processor is configured to calculate, based on the demand forecast information and the inventory shortage risk information obtained from the generative AI model and the inventory state, a movement prediction and a demand peak period for each object, to determine an execution timing of at least one operation selected from lending, transferring, replenishing, and changing shelf allocation in accordance with the demand peak period, and to notify the execution timing and contents of the operation to the information terminal apparatus and the robotic apparatus.

### Example 2

### (Supplementary 1)

A system comprising a processor,
wherein the processor is configured to acquire identification information of a physical object provided with a wireless identification tag and position information of the physical object as position information, by using a position information collection unit,
store, by using an information storage unit, the position information of the physical object acquired from the position information collection unit and movement history information of the physical object, in association with inventory information and sales history information, estimate, by using an emotion estimation unit, an emotion state of a user on a basis of at least one of image information of the user acquired by an imaging device, voice information of the user acquired by a voice acquisition device, and operation history information of the user acquired by an operation input device, and store an emotion state history and a latest emotion state for each user,
generate, by using a generative AI processing unit, a prompt sentence that includes a summary of input information, preconditions, constraint conditions, and an output format, the input information including movement history information of the physical object, the inventory information, and the sales history information stored in the information storage unit and the emotion state of the user estimated by the emotion estimation unit, and supply the prompt sentence and the input information to a generative machine learning model so as to cause the generative machine learning model to generate prediction information regarding future movement or demand of the physical object,
generate, by using an instruction generation unit, instruction information that includes an execution timing and an assignment of a responsible person for at least one of lending, returning, shipping, storing, transshipment work, and customer support relating to the physical object, on a basis of the prediction information generated by the generative AI processing unit and the emotion state estimated by the emotion estimation unit, and transmit the instruction information to a terminal device, and
receive, by using a feedback unit, performance information relating to a work start and a work completion transmitted from the terminal device, calculate a difference between the performance information and the prediction information, update a statistical index on a basis of the difference, and dynamically improve a template of the prompt sentence and an input parameter to the generative machine learning model on a basis of the updated statistical index and a transition of the emotion state.

### (Supplementary 2)

The system according to supplementary 1,
wherein the processor is configured to
cause the position information collection unit to detect the identification information and a reception signal strength of the wireless identification tag within a predetermined range by using a wireless identification tag reading device, associate a position of the terminal device acquired by a position information acquisition function of the terminal device with the identification information as a position information record, and transmit the position information record to the information storage unit, and
cause the information storage unit to record a movement history of each physical object by updating position information for each wireless identification tag in real time and storing past position information.

### (Supplementary 3)

The system according to supplementary 1,
wherein the processor is configured to
cause the generative AI processing unit to predict at least one of a next movement direction, a movement time, and a demand quantity of the physical object by using a generative machine learning algorithm that analyzes input information including real-time position information and past movement history information of the physical object acquired from the information storage unit and an emotion state of a worker or a customer estimated by the emotion estimation unit, and
cause the instruction generation unit to transmit, on a basis of the prediction information by the generative AI processing unit and constraint conditions according to the emotion state, a notification to a terminal device of a user or a worker in accordance with a predicted time when the physical object arrives at a specific place or a predicted time when demand occurs, and to transmit, when transshipment is required, a notification to a worker at an optimal timing in consideration of safety and workload leveling.

### Application Example 2

### (Supplementary 1)

A system comprising a processor,
wherein the processor is configured to
acquire identification information of a wireless identification tag attached to an object by wireless communication, and generate position information by associating the identification information with area identification information indicating an area in which the wireless identification tag is present,
store, in a storage medium, the position information generated as above, inventory information based on the position information, and history information related to the object in association with time information,
receive, from an information processing terminal held by a worker, at least one of image data, audio data, and biological signal data acquired by an imaging device, an audio acquisition device, or a biological information acquisition device of the information processing terminal, and estimate an emotional state of the worker as a numerical index on the basis of the received data,
convert, into text data, at least inventory information and history information stored in the storage medium, generate a prompt sentence as input for a generative AI model using the text data, transmit the prompt sentence to the generative AI model, receive response text from the generative AI model, and analyze the response text to calculate demand prediction information or movement prediction information related to the object,
determine, on the basis of at least the demand prediction information or the movement prediction information, the emotional state, the inventory information, and the position information, contents and execution order of work tasks related to allocation, replenishment, transport, or handling of the object and assignment of workers in charge of the work tasks, dynamically modify a work plan by, among the work tasks determined as above, reducing high-load tasks assigned to a worker whose emotional state exceeds a predetermined threshold, and reallocating the high-load tasks among a plurality of workers so that workloads of the plurality of workers are substantially equalized, and
output work instruction information to the information processing terminal on the basis of the work plan after the dynamic modification, and control presentation contents on the information processing terminal such that, in accordance with the emotional state of the worker, at least one of single-task display and multiple-task list display is selected as a display format.

### (Supplementary 2)

The system according to supplementary 1,
wherein the processor is configured to
acquire, from the storage medium, sales history information and inventory information related to the object, format the acquired information as a character string sequence including dates and quantities, generate a prompt sentence including the character string sequence, transmit the prompt sentence to the generative AI model, receive text data as a response from the generative AI model, extract, from the text data, forecast demand values for respective dates and information on peak demand periods, and record the forecast demand values and the information on the peak demand periods as demand prediction information in the storage medium.

### (Supplementary 3)

The system according to supplementary 1,
wherein the processor is configured to
acquire, from the storage medium, inventory information, demand prediction information, and statistical information of the emotional state for each worker, format the acquired information as table-form text data, generate a prompt sentence including the table-form text data and constraint conditions related to workload equalization and avoidance of high-risk work, transmit the prompt sentence to the generative AI model, receive work assignment proposal text data as a response from the generative AI model, analyze the work assignment proposal text data, and register, in the storage medium, work task information including a worker identifier, a time slot, a position identifier, an object identifier, and a quantity.

What is claimed is:

1. A system comprising:
circuitry configured to:
receive, via a communication interface operating over a packet-switched network, data records from a plurality of wireless reading devices, each data record comprising an identifier read from a wireless tag and a time stamp;
store the data records in a storage medium and generate time-series history information by associating the data records with location information of the respective wireless reading devices;
extract, from the time-series history information, a subset of the data records satisfying a predetermined extraction condition, and convert the extracted subset into structured data;
generate a prompt sentence in a natural language based on the structured data, and transmit the prompt sentence to a generative information processing model via the communication interface to obtain prediction information from the generative information processing model;
generate, based on the prediction information, instruction data specifying at least a time parameter and a sequence parameter; and
transmit the instruction data to a client terminal via the packet-switched network.

2. The system according to claim 1, wherein the wireless reading devices comprise radio frequency identification readers, and the wireless tags comprise radio frequency identification tags each storing unique identification information.

3. The system according to claim 2, wherein each data record further comprises installation position information of the respective wireless reading device, and the circuitry generates the time-series history information by normalizing the data records into current position information and movement history information for each item associated with a respective wireless tag.

4. The system according to claim 3, wherein the circuitry is further configured to extract the subset of the data records based on at least one of a time range condition, an item category condition, and a location range condition.

5. The system according to claim 4, wherein the structured data comprises time-series movement history information, and the prompt sentence further comprises an instruction sentence defining a content and an output format of prediction requested from the generative information processing model.

6. The system according to claim 5, wherein the prediction information comprises at least one of a future destination, a future movement time, and a future demand quantity for each item.

7. The system according to claim 6, wherein the instruction data comprises task instruction information including at least one of a start time, an execution order, and an assigned apparatus for at least one of a transfer operation, a storage operation, and a replenishment operation.

8. The system according to claim 7, wherein the circuitry is further configured to distribute the instruction data to at least one of the client terminal comprising a display device, an alarm device, and a robotic apparatus, and the client terminal notifies a worker based on the instruction data.

9. The system according to claim 8, wherein the circuitry is further configured to receive, from the client terminal, work result information generated based on at least one of operation input from the worker and subsequently acquired data records, and store the work result information in the storage medium as evaluation data associated with the movement history information and the prediction information.

10. The system according to claim 9, wherein the circuitry is further configured to calculate a prediction error based on at least one of a time difference and a position difference between the prediction information and the work result information, and adjust the prompt sentence by updating at least one of a period, an item, and a weight of history information included in the prompt sentence in accordance with the prediction error.

11. The system according to claim 1, wherein the prompt sentence comprises a description sentence containing at least part of the time-series history information and operation condition information, and the circuitry is further configured to automatically improve contents of the prompt sentence by variably changing a composition of the description sentence in accordance with prediction accuracy.

12. The system according to claim 1, wherein the time-series history information further comprises past sales information and shipment information stored in time series, and the circuitry generates feature data of inventory amounts and demand for each item from the time-series history information and converts the feature data into a natural language format or a table format for inclusion in the prompt sentence.

13. The system according to claim 12, wherein the prediction information comprises demand forecast information and inventory shortage risk information, and the circuitry calculates, based on the demand forecast information and an inventory state, a replenishment amount, a relocation amount, and an ordering time for each item.

14. The system according to claim 13, wherein the circuitry is further configured to transmit control instructions related to transport and picking of items to a robotic apparatus via the packet-switched network, and transmit electronic ordering information to a supply apparatus via the packet-switched network.

15. The system according to claim 14, wherein the circuitry is further configured to receive work completion information and correction information from the client terminal, update the inventory state and the time-series history information based on the work completion information and the correction information, and reflect an update result in generation of a subsequent prompt sentence.

16. The system according to claim 1, wherein the prompt sentence includes statistical information indicating, for each item, a quantity metric in a predetermined past period and a current quantity, and a description that requests the generative information processing model to output, in a predetermined structured format, a future demand amount for each item and a probability of a shortage.

17. The system according to claim 16, wherein the circuitry is further configured to calculate, based on the prediction information and the time-series history information, a demand peak period for each item, determine an execution timing of at least one operation in accordance with the demand peak period, and notify the execution timing and contents of the operation to the client terminal.

18. A system comprising:
circuitry configured to:
receive, via a communication interface operating over a packet-switched network using a transport layer security protocol, data records from a plurality of wireless reading devices, each data record comprising an identifier read from a radio frequency identification tag and a time stamp and installation position information of the respective wireless reading device;
store the data records in a storage medium and generate time-series history information by normalizing the data records into current position information and movement history information for each item associated with a respective radio frequency identification tag;
extract, from the time-series history information, a subset of the data records satisfying a predetermined extraction condition based on at least one of a time range condition, an item category condition, and a location range condition, and convert the extracted subset into structured data comprising time-series movement history information;
generate a prompt sentence in a natural language based on the structured data and operation condition information, the prompt sentence comprising a description sentence containing at least part of the time-series movement history information and an instruction sentence defining a content and an output format of prediction, and transmit the prompt sentence to a generative information processing model via the communication interface;
receive, from the generative information processing model, prediction information comprising at least one of a future destination, a future movement time, and a future demand quantity;
generate, based on the prediction information, task instruction information comprising at least one of a start time, an execution order, and an assigned apparatus for at least one of a transfer operation, a storage operation, and a replenishment operation;
distribute the task instruction information to a client terminal via the packet-switched network for notification to a worker;
receive, from the client terminal, work result information, and store the work result information in the storage medium as evaluation data associated with the prediction information; and
calculate a prediction error based on at least one of a time difference and a position difference between the prediction information and the work result information, and adjust the prompt sentence by updating at least one of a period, an item, and a weight of history information included in the prompt sentence in accordance with the prediction error.

19. The system according to claim 18, wherein the time-series history information further comprises past sales information and shipment information, and the circuitry is further configured to generate feature data of inventory amounts and demand for each item, convert the feature data into a natural language format for inclusion in the prompt sentence, and calculate, based on demand forecast information obtained from the generative information processing model and an inventory state, a replenishment amount and an ordering time for each item.

20. A method performed by circuitry of a system, the method comprising:
receiving, via a communication interface operating over a packet-switched network, data records from a plurality of wireless reading devices, each data record comprising an identifier read from a wireless tag and a time stamp;
storing the data records in a storage medium and generating time-series history information by associating the data records with location information of the respective wireless reading devices;
extracting, from the time-series history information, a subset of the data records satisfying a predetermined extraction condition, and converting the extracted subset into structured data;
generating a prompt sentence in a natural language based on the structured data, and transmitting the prompt sentence to a generative information processing model via the communication interface to obtain prediction information from the generative information processing model;
generating, based on the prediction information, instruction data specifying at least a time parameter and a sequence parameter; and
transmitting the instruction data to a client terminal via the packet-switched network.
